(19) United States
(12) Patent Application Publication
(10) Pub. No.: US 2008/0134258 A1
(43) Pub. Date: Jun. 5, 2008

(54) Multi-Source and Resilient Video on Demand Streaming System for a Peer-to-Peer Subscriber Community

(76) Inventors: Stuart Goose, Berkeley, CA (US); Ahsan Habib, El Cerrito, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/664,630

(22) PCT Filed: Aug. 9, 2006
(86) PCT No.: PCT/US06/31011

§ 371 Date: Apr. 3, 2007

Related U.S. Application Data
(60) Provisional application No. 60/708,020, filed on Aug. 12, 2005.
(60) Provisional application No. 60/749,730, filed on Dec. 12, 2005.

(51) Int. Cl. H04N 7/173

(52) U.S. Cl. 725/91

(57) ABSTRACT

Centralized video on demand (VoD) systems offer limited content and limited archival ability. Peer-to-peer networks allow users to share a wide selection of content directly among peers, but connections between peers may have limited uplink bandwidth and may be unreliable. The present invention according to various embodiments contemplates systems and methods for high quality and resilient transmission of streaming data from one or more sources within a heterogeneous peer-to-peer network to address these and other problems

### CROSS-REFERENCE TO RELATED APPLICATIONS

This application claims the benefit of and hereby incorporates by reference U.S. Provisional Application 60/708,020 filed Aug. 12, 2005 (Attorney Docket 2005P14442US) and U.S. Provisional Application 60/749,730 filed Dec. 12, 2005 (Attorney Docket 2005P22668US), both entitled “A Multi-Source and Resilient Video Streaming System for Peer-to-Peer Networks” and having the same inventors as this application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention is related to streaming data, and more specifically to on demand streaming data from one or more sources in a peer-to-peer subscriber community network.

### BACKGROUND OF THE INVENTION

A set top box (STB) is a device that enables a television set to become a user interface to a service provider's network for services such as playing and recording TV programs. Using a personal video recorder (PVR) feature of a STB, a user can record the broadcasted content to watch at a later time.

A video on demand (VoD) system allows a user to request a particular TV program or other video content for playing and possibly recording it using a STB. In a typical VoD system, a user may use a STB to interface to a centralized service provider's network, and may use an electronic program guide (EPG) in order to browse through a selection of available content offered by the service provider and select a program for viewing. Video data is typically transmitted over the service provider's network to the user's STB as streaming data.

Generally also, a peer-to-peer network allows users sharing the same networking protocols and software to interconnect with each other and directly access each other's resources. For example, a service provider may provide a peer-to-peer network to allow computer users to connect their computers to the network and to directly access each other's resources, such as digital content files. A service provider may provide a peer-to-peer network to allow users of other devices, such as STBs, to connect their devices to the network and to directly access each other's resources, including stored video content and TV programs. A subscriber community peer-to-peer network allows the community of subscribers to directly access resources from one another. A user may download data from one or more peers, typically receiving it as streaming data.

The ever-increasing bandwidth and resiliency demands of service providers' networks are a challenge, however, as traditional streaming solutions do not keep up with these demands. Contemporary VoD solutions such as the one illustrated in FIG. 1 typically provide a modest selection of movie titles and may cache only the premium content for a limited time period, such as 24 hours. However, if the subscribers to a VoD system were able to select the content they want to view and when they want to view it (i.e., on demand), the VoD approach would likely be used more frequently. This would increase customer satisfaction, and for the service provider it would increase revenue and decrease chum.

### SUMMARY OF THE INVENTION

Accordingly, in order to, among other things, augment a VoD system, the present invention relates to a peer-to-peer (p2p) network among STBs, where each STB is a node of the network, according to specific embodiments. Moreover, specific embodiments of this invention relate to multi-source streaming technology called VoD-to-Peer (V2P) that enables any peer STB in a service provider's network to obtain and watch video content from other STBs in the network. Such V2P network according to embodiments of the invention thus effectively becomes a VoD system for a subscriber community in which any of its members can obtain and watch content downloaded and/or recorded by any of its other members.

Because, typically, the subscriber community includes a set of STBs, V2P is a multi-source video streaming system that enables on demand viewing of content from STBs. The architecture of a V2P system designed in accordance with the principles of the present invention is presented here along with a description of each component of the architecture. Such a V2P system is responsible for resilient and high quality video streaming.

According to a specific embodiment, the invention provides a system for providing on demand streaming data in a service provider's subscriber community peer-to-peer network. The system includes a service provider operative to supply downloadable and recordable content that can be supplied as streaming data after it is downloaded or recorded, and a subscriber community peer-to-peer network of devices associated with the service provider and adapted to interface with a television set. The system further includes a receiver which is a node in the service provider's subscriber community peer-to-peer network, and a set of suppliers, including active and backup suppliers. Each supplier is a node in the service provider's subscriber community peer-to-peer network and each supplier is operative to supply on demand streaming data after downloading and/or recording content from either the service provider or from one or more of the other nodes. The receiver is operative to receive streaming data that is streamed on demand by the receiver from one or more suppliers in the set of suppliers.

According to another specific embodiment, the invention provides a method for providing on demand streaming data in a service provider's subscriber community peer-to-peer network. The method includes the steps of providing a subscriber community peer-to-peer network for subscribers of a service provider, providing downloadable and recordable content that may be downloaded and/or recorded and subsequently supplied on demand as streaming data, and providing a search engine associated with the subscriber community peer-to-peer network. The method provides a step of connecting the subscribers to the subscriber community peer-to-peer network, and enabling each subscriber to use the search engine, in order to search for content previously downloaded or recorded by other subscribers connected to the subscriber community peer-to-peer network, and to receive on demand such downloaded and/or recorded content as streaming data from one or more of the other subscribers.

According to still another specific embodiment, the invention provides a system for receiving on demand streaming data in a subscriber community peer-to-peer network. The system includes a subscriber community peer-to-peer network, a receiver of streaming data that is a node in the subscriber community peer-to-peer network, and a set of suppliers of streaming data. The set of suppliers includes a set of active suppliers and a set of backup suppliers, where each supplier in the set of suppliers is a node in the subscriber community peer-to-peer network. The streaming data includes multiple blocks. For each block of streaming data to be received on demand, the receiver is operative to utilize an FEC encoding overhead ratio, signal each active supplier to send at an individually assigned data rate at least an individually assigned fraction of the block FEC-encoded using the FEC encoding overhead ratio, receive segments of the FEC-encoded block wherein each segment represents at least a part of the individually assigned fractions, decode the FEC-encoded block based on the aggregate of the segments and store the decoded block in a buffer, monitor the performance of a network connection with each active supplier, and monitor the buffer to detect conditions that would result in overflow or underflow, based on the performance of the network connections and conditions of the buffer, perform quality adaptation to avoid reaching an underflow or overflow of the buffer.

According another specific embodiment, the present invention provides a method for receiving on demand streaming data in a subscriber community peer-to-peer network. The method includes the steps of selecting a set of suppliers from a set of candidate suppliers in a subscriber community peer-to-peer network to be a set of active suppliers and selecting another set of suppliers from the set of candidate suppliers to be a set of backup suppliers. The method, for each block of streaming data to be received, includes the steps of utilizing an FEC encoding overhead ratio, signaling each active supplier to send at an individually assigned data rate at least an individually assigned fraction of the block FEC-encoded using the FEC encoding overhead ratio, receiving segments of the FEC-encoded block wherein each segment represents at least a part of the individually assigned fractions, decoding the FEC-encoded block based on the aggregate of the segments and storing the decoded block in a buffer, monitoring the performance of a network connection with each active supplier, monitoring the buffer to detect conditions that would result in overflow or underflow, and based on the performance of the network connections and conditions of the buffer, performing quality adaptation to avoid reaching an underflow or overflow of the buffer.

According to another specific embodiment, the present invention provides a system for supplying on demand streaming data in a subscriber community peer-to-peer network. The system includes a receiver that is a node in a subscriber community peer-to-peer network, and a set suppliers with streaming data, where each supplier in the set of suppliers is a node in the subscriber community peer-to-peer network. The streaming data includes multiple blocks and for each block of streaming data to be supplied, each supplier is operative to receive a signal from the receiver indicating an FEC encoding overhead ratio to be utilized, an individually assigned data rate, and an individually assigned fraction of the FEC-encoded block resulting from an FEC encoding operation on the block utilizing the FEC encoding overhead ratio; and send at least part of the assigned fraction of the FEC-encoded block at the individually assigned data rate.

According to a further specific embodiment, the present invention provides a method for supplying on demand streaming data in a subscriber community peer-to-peer network. For each block of streaming data to be received by a receiver in a subscriber community peer-to-peer network, the method includes receiving a signal from the receiver indicating an FEC encoding overhead ratio to be utilized, an individually assigned data rate, and an individually assigned fraction of the FEC-encoded block resulting from an FEC encoding operation on the block utilizing the FEC encoding overhead ratio; and sending to the receiver at least part of the assigned fraction of the FEC-encoded block at the individually assigned data rate.

According to another specific embodiment, the invention provides a method for simulating fast-forward or fast-rewind playback of streaming video data. The method includes steps of receiving streaming video data at a streaming rate, storing the received streaming video data in a buffer for subsequent playback at a playback rate corresponding to a normal speed, and
playing the stored streaming video data from the buffer at a speed higher than the normal speed.
   The method also includes the steps of monitoring the buffer for an underflow condition where the streaming rate is less than the playback rate, and based on detecting an underflow condition, inserting a pre-determined video clip into the buffer between stored streaming video data.

According to yet another specific embodiment, the invention provides a method for simulating fast-forward or fast-rewind playback of streaming video data. The method includes the steps of receiving streaming video data from a video file at a streaming rate, storing the received streaming video data in a buffer for subsequent playback at a normal playback rate corresponding to a normal viewing speed, and receiving a command for fast-forward playback at a speedup playback rate corresponding to a speedup viewing speed. The method also includes the steps of receiving streaming video data beginning from a jump point in the video file, and playing the stored streaming video data from the buffer at playback rate higher than the normal playback speed to simulate playback at the speedup playback rate.

These and other specific embodiments of the invention are described in more detail as follows.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates a system for implementing a conventional video on demand (VoD) service.

FIG. 2 illustrates one system embodiment for augmenting a conventional video on demand (VoD) service with additional content supplied by a peer-to-peer network.

FIG. 3 is a graph illustrating the long tail.

FIG. 4 illustrates one embodiment of a VoD-to-peer (V2P) system.

FIG. 5 is a flow diagram illustrating a method for performing a streaming session using a V2P system.

FIG. 6 is a block diagram illustrating one embodiment of a V2P system.

FIG. 7 is a graph of a peer selection rank equation.

FIG. 8 is a block diagram illustrating a V2P receiver including details of a stream management module.

FIG. 9 is a graph illustrating how a dynamic buffer management technique can avoid a buffer overflow or underflow.

FIG. 10 is a graph illustrating a buffer management scheme.

FIG. 11 illustrates a simple binary tree used in connection monitoring.

FIG. 12 illustrates a sequence of MPEG frames.

FIG. 13 illustrates a video clip inserted between video data to simulate a fast-forward operation.

FIG. 14 is a block diagram illustrating one embodiment of a V2P system.

FIG. 15 presents an exemplary setup for evaluating a V2P system.

FIG. 16 illustrates a V2P system implemented in a high-bandwidth environment.

FIG. 17 is a block diagram of one embodiment of a V2P system.

FIG. 18 is a graph illustrating TV viewing behavior and the long tail.

FIG. 19A is a graph illustrating the number of concurrent streams a V2P system can deliver at Standard Definition (SD) quality.

FIG. 19B is a graph illustrating the maximum, or cumulative, number of streams that a V2P system can deliver at SD quality.

FIG. 20A is a graph illustrating the number of concurrent streams a V2P system can deliver at near DVD quality.

FIG. 20B is a graph illustrating the number of concurrent streams a V2P system can deliver at near DVD quality.

FIG. 21A is a graph illustrating the number of concurrent streams a V2P system can deliver at near DVD quality.

FIG. 21B is a graph illustrating the number of concurrent streams a V2P system can deliver at near DVD quality.

FIG. 22 is a graph illustrating the archival aspect of a V2P system.

FIG. 23 is a flow diagram illustrating a method for identifying a common video frame.

### DETAILED DESCRIPTION OF SPECIFIC EMBODIMENTS OF THE INVENTION

As mentioned above, in order to, among other things, augment a VoD system, the present invention relates to a peer-to-peer (p2p) network among STBs, where each STB is a node of the network, according to specific embodiments. Moreover, specific embodiments of this invention relate to multi-source streaming technology called VoD-to-Peer (V2P) that enables any peer STB in a service provider's network to obtain and watch video content from other STBs in the network. Such V2P network according to embodiments of the invention thus effectively becomes a VoD system for a subscriber community in which any of its members can obtain and watch content downloaded and/or recorded by any of its other members.

Because, typically, the subscriber community includes a set of STBs, V2P is a multi-source video streaming system that enables on demand viewing of content from STBs. The architecture of a V2P system designed in accordance with the principles of the present invention is presented here along with a description of each component of the architecture. Such a V2P system is responsible for resilient and high quality video streaming.

Advantageously, a service provider offering V2P service would be able to prevent illegal video distribution over a p2p network managed by it. Specifically, the service provider can restrict content recorded by the subscriber STBs to content provided by the service provider so that there is no mechanism for introducing new video content into the STBs (i.e., the system is closed-in as far as the subscriber is concerned). Any subsequent sharing of video content among peer STBs is limited to the closed-in community of STB peers that are customers (subscribers) of the service provider. The p2p network may be extended to allow any personal computer (PC) or other suitable device to be connected to this P2P network with no illegal sharing of content.

As for service providers, the present invention contemplates various embodiments of systems and methods for providing on demand streaming data in a service provider's subscriber community peer-to-peer network. One embodiment of a system for providing on demand streaming data in a service provider's subscriber community peer-to-peer network includes a subscriber community peer-to-peer network of devices adapted to be interfaced with a television set and a service provider operative to supply downloadable and recordable content that can be supplied as streaming data after it is downloaded or recorded. In this system, there is a receiver of content and a set of suppliers, including active and backup suppliers, of streaming data that provide the content. Each supplier is operative to supply on demand streaming data after downloading or recording content from either the service provider or from one or more of the other nodes. The receiver in such a system is operative to receive data that is streamed, on demand by the receiver, from one or more suppliers in the set of suppliers. The receiver and the suppliers are each a node in the subscriber community peer-to-peer network, and each node may be a set top box or any other device adapted to be interfaced with a television set and a service provider's network. The service provider provides content such as audio data, video data, or both that is downloadable and recordable by the nodes in the subscriber community; and this downloadable and recordable content may be supplied as streaming data from nodes acting as suppliers.

Such system can be enhanced by a search engine that allows users to browse content using a content browser and to receive content recommendations from a content recommender, according to various embodiments. This system can be further enhanced by an incentive manager that provides rewards to content owners, to service providers, and to suppliers for participating in streaming sessions, according to other embodiments. According to further embodiments, this system can be additionally enhanced by a digital rights manager that prevents illegal distribution of content.

In connection with the foregoing, according to a specific embodiment, the invention provides a method for providing on demand streaming data in a service provider's subscriber community peer-to-peer network includes, after providing a subscriber community peer-to-peer network for subscribers of the service provider, connecting the subscribers thereto. The method includes providing downloadable and recordable content that may be downloaded and/or recorded and subsequently supplied on demand as streaming data. The method also includes providing a search engine associated with the subscriber community peer-to-peer network and enabling each subscriber to use the search engine and receive selected data on demand. Specifically, subscribers use the search engine in order to search for content previously downloaded or recorded by other subscribers connected to the subscriber community peer-to-peer network. Then, subscribers receive on demand such downloaded and/or recorded content as streaming data from one or more of the other subscribers.

As for receiving on-demand content, various embodiments of the present invention also provide systems and methods for receiving on demand streaming data from one or more suppliers in a subscriber community peer-to-peer network. One such system includes a node operating as a receiver and a set of nodes operating as suppliers of streaming data, including a set of active suppliers and a set of backup suppliers. In other words, the receiver as well as each supplier in the set of suppliers is a node in the subscriber community peer-to-peer network. A receiver in such a system receives streaming data, including audio data, video data, or both. For each block of streaming data to be received, the receiver utilizes an FEC encoding overhead ratio and it signals each active supplier to send at an individually assigned data rate at least an individually assigned fraction of the block that is FEC-encoded using the FEC encoding overhead ratio. The receiver receives segments of the FEC-encoded block wherein each segment represents at least a part of the individually assigned fractions, decodes the FEC-encoded block based on the aggregate of the segments and stores the decoded block in a buffer. The receiver monitors the performance of the network connection with each active supplier and monitors the buffer to detect conditions that would result in overflow or underflow. Based on the performance of the connections and conditions of the buffer, the receiver performs quality adaptation to avoid reaching an underflow or overflow of the buffer. The monitoring detects supplier failure or content deletion in the middle of a streaming session and uses a set of techniques such as backup peer addition to the active set, rate redistribution among the active suppliers, and FEC encoding overhead adjustment to deal with supplier failure and content deletion.

As mentioned, each of the receiver and the suppliers is a node in the subscriber community peer-to-peer network, and each such device may be adapted to be interfaced with a television set and a service provider's network. In other words, such devices may be set top boxes, personal computers or mobile computing devices, according to various embodiments. Each of the devices may operate as a receiver, supplier, or both. Suppliers are selected based on any combination of one or more metrics that may include a supplier's supplying or receiving status, available uplink bandwidth, processing power, reliability history, path latency, packet loss, and fairness. A supplier's reliability history may be based on device failure rate, network connection time, and content availability, according to specific embodiments. Fairness may be based on load balancing and prior selection history.

According to specific embodiments, the receiver in such a system is operative to adapt the streaming session based on monitoring the performance of the network connection with each active supplier, including detecting whether a supplier has experienced a network fluctuation, a device failure, or deleted the content to be supplied as streaming data. The receiver is operative to also monitor the performance of each network connection passively based on metrics of streaming data actually received from each supplier. The receiver also adapts the streaming session based on monitoring the buffer, including the current buffer size, the current playing rate, and the current streaming rate. If necessary, the receiver may dynamically adjust the rate distribution among active suppliers, adjust the sets of suppliers, or adjust the FEC encoding parameters. The receiver is also operative to adjust the rate distribution among active suppliers by assigning a new data rate or by assigning a new fraction of a block. The receiver may adjust the set of active suppliers by adding or removing an active supplier, adding a backup supplier to the set of active suppliers, or adding a supplier to the set of backup suppliers, according to various embodiments. The receiver may adjust the FEC encoding parameters by utilizing a new FEC encoding overhead ratio or by utilizing a new FEC encoding scheme. By utilizing an FEC encoding overhead ratio, the receiver may set the FEC encoding overhead ratio to be used by a supplier in subsequent FEC encoding of a block or it may simply signal a supplier to select a pre-encoded block FEC-encoded with the specific FEC encoding overhead ratio.

The receiver in such a system also determines a common starting point within multiple individual copies of a media file to be used as a source of streaming data among the set of active suppliers, according to specific embodiments. The receiver defines a time interval and receives from each active supplier a set of reference objects. The time interval may be related to a clock synchronization of devices connected to the subscriber community network. Each of the reference objects corresponds to a reference frame occurring within the individual copies of the media file during the time interval. The receiver compares the received sets of reference objects to identify a common reference object that is common to all sets of reference objects and sets the starting point to be the reference frame corresponding to the common reference object. In a video file, each reference frame may be a video frame and each reference object may be a hash value.

As for supplying content on demand, the present invention according to specific embodiments also provides systems and methods for supplying on demand streaming data in a subscriber community peer-to-peer network. One such embodiment includes a receiver that is a node in this network and a set of suppliers of multiple blocks of streaming data, where each supplier in the set of suppliers is also a node in this network. For each block of streaming data to supply, each supplier in such a system receives a signal from the receiver indicating an FEC encoding overhead ratio to be utilized, an individually assigned data rate, and an individually assigned fraction of the FEC-encoded block resulting from an FEC encoding operation on the block utilizing the FEC encoding overhead ratio. Each supplier then sends at least part of the assigned fraction of the FEC-encoded block at the individually assigned data rate.

In addition to the foregoing, various embodiments of the present invention include systems and methods for simulating fast-forward and fast-rewind playback of streaming video data. One embodiment of a method for simulating fast-forward or fast-rewind playback of streaming video data involves receiving streaming video data at a streaming rate, storing the received streaming video data in a buffer for subsequent playback at a playback rate corresponding to a normal speed, monitoring the buffer for an underflow condition where the streaming rate is less than the playback rate, and inserting a predetermined video clip into the buffer between stored streaming video data.

Another embodiment of a method for simulating fast-forward and fast-rewind playback of streaming video data involves receiving streaming video data from a video file at a streaming rate, storing the received streaming video data in a buffer for subsequent playback at a normal playback rate corresponding to a normal viewing speed. This method further involves receiving a command for fast-forward or fast-rewind playback at a speedup playback rate corresponding to a speedup viewing speed, receiving streaming video data beginning from a jump point in the video file, and playing the stored streaming video data from the buffer at playback rate higher than the normal playback speed to simulate playback at the speedup playback rate. Such a method may also include inserting a pre-determined video clip into the buffer between stored streaming video data.

In the following description, reference is made to the accompanying drawings in which are shown by way of illustration a number of embodiments and the manner of practicing the invention. It is to be understood that other embodiments may be utilized and structural and functional changes may be made without departing from the scope of the present invention.

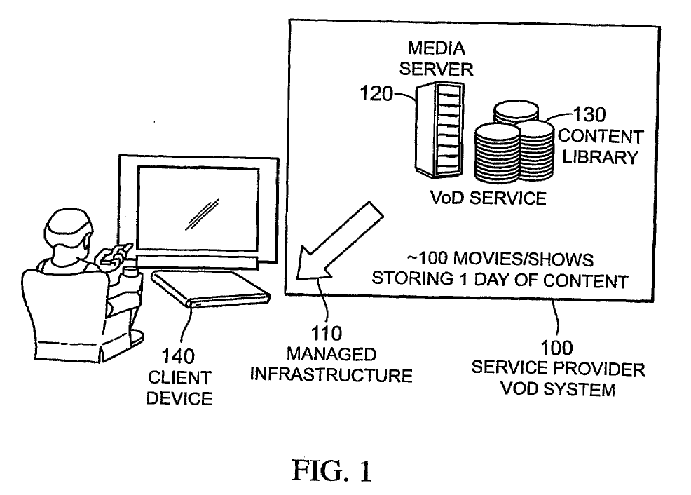

To provide context for the description of the specific embodiments of the present invention, FIG. 1 presents a system for implementing a conventional video on demand (VoD) service. An infrastructure-based media streaming, or centralized video on demand (VoD), solution generally comprises one or more media servers, and a set of clients, usually set top boxes (STBs). The media servers are responsible for the on demand streaming of the media to the clients. In some cases, such a VoD system may further comprise caching proxies. As shown in FIG. 1, a service provider VoD system 100 comprises a managed infrastructure 110, a media server 120, and a content library 130. A client device 140, shown here as a set top box (STB), is communicatively coupled with the service provider 100 and receives downloaded or streamed content from content library 130 as part of a video on demand service. Managed infrastructure 110 handles downloading and streaming requests from client device 140 and manages the control and data connections between service provider 100 and client device 140. For example, media server 120 performs on demand streaming of requested media from content library 130 to client device 140 over the managed infrastructure 110.

As mentioned before, conventional VoD solutions such as the one illustrated in FIG. 1 typically provide a modest selection of movie titles and may cache only the premium content for a limited time period, such as 24 hours. However, if the subscribers to a VoD system are empowered to view exactly what content they want to view when they want (i.e., on demand), the VoD approach is likely to be used more frequently. This increases customer satisfaction, and for the service provider it increases revenue and decreases chum.

A set top box (STB) is a device that enables a television set to become a user interface to a service provider's network for services such as playing and recording TV programs using a personal video recorder (PVR) feature of the STB. According to one embodiment of the present invention, every subscriber's STB connects to a service provider managed peer-to-peer (p2p) network, thus enabling any subscriber to the service provider's network to stream video content that was downloaded and/or recorded on that subscriber's STB to the STBs of other fellow subscribers.

For example, any subscriber may download and/or record in its STB any TV program or other content provided by the service provider. The content may be automatically announced or registered to the service provider's p2p network in order to make it available to other subscribers. Any subscriber of the network can search this content and view it. Such a system, called V2P, is a multi-source video streaming system for the p2p network formed by the STBs. That is, V2P provides high quality and resilient video streaming from multiple STBs.

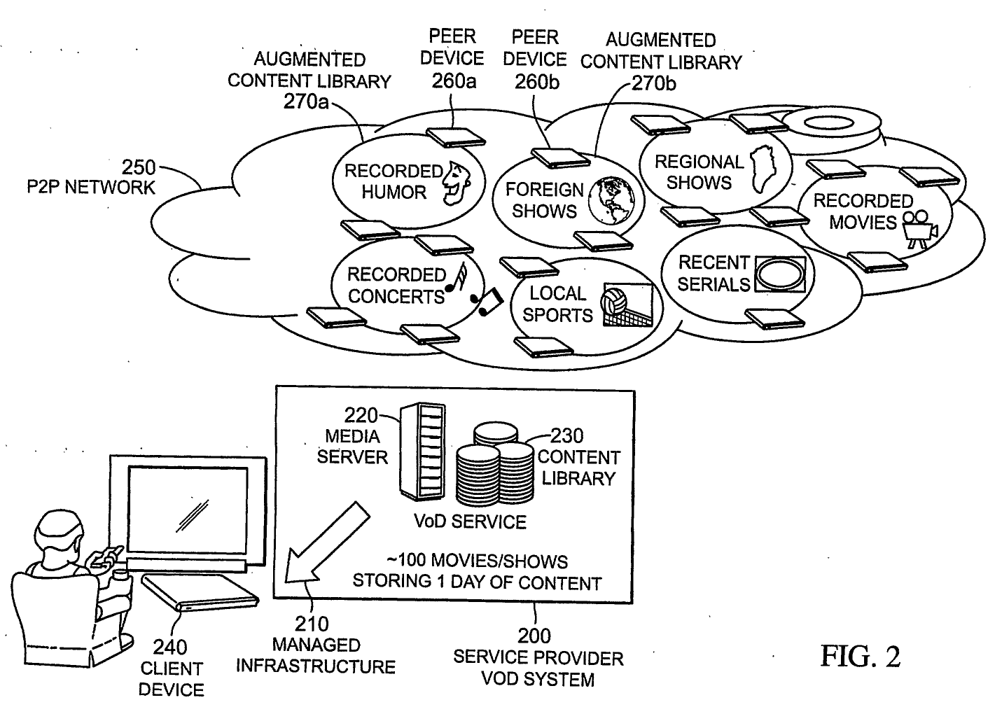

To this end, FIG. 2 illustrates a system for augmenting a conventional video on demand (VoD) service with additional content supplied by a peer-to-peer network to create a community VoD system according to one embodiment of the present invention. As shown, a service provider VoD system 200 comprises a managed infrastructure 210, a media server 220, a content library 230, and a service provider managed peer-to-peer (p2p) network 250. The p2p network 250 further comprises peer devices 260a, 260b, 260c, shown here as set top boxes (STBs), hereinafter identified as peer devices 260, and augmented content library 270a and 270b, hereinafter identified as augmented content library 270. Augmented content library 270 comprises downloaded and/or recorded content stored on peer devices 260. For example, peer devices 260 may download and/or record and store streamed media from content library 230 over managed infrastructure 210. Augmenting the VoD system's content library 230 with the augmented content recorded by any subscriber connected to the p2p network 250 yields an increased choice of content and creates a community VoD system.

According to a specific embodiment, a client device 240, shown here as a set top box (STB), is communicatively coupled with the service provider VoD system 200 and receives downloaded or streamed content from either content library 230 or from augmented content library 270 as part of a video on demand service. Managed infrastructure 210 handles downloading and streaming requests from client device 240 and manages the control and data connections between service provider VoD network 200 and client device 240. For example, media server 220 performs on demand streaming of requested media from content library 230 to client device 240 over managed infrastructure 210. Also, client device 240 may request on demand streaming of requested media from augmented content library 270. The p2p network 250 handles these requests and manages the control and data connections between p2p network 250 and client device 240 to perform on demand streaming of requested media from augmented content library 250 to client device 240.

A V2P solution is not necessarily meant as a replacement for a centralized VoD solution such as the one illustrated in FIG. 1, but may serve as a complementary distributed augmentation to such a solution, as shown in FIG. 2. Together, VoD and V2P may bring a huge volume of content to the subscribers. Centralized VoD can continue to serve the majority of the most popular content programs, whereas V2P is well suited to serve the so-called “long tail” market.

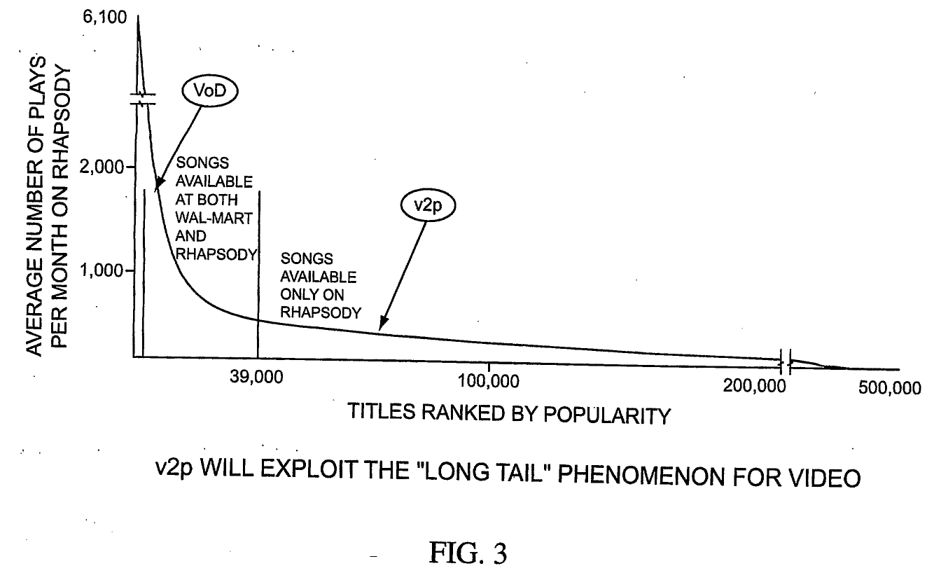

FIG. 3 is a graph illustrating the long tail. According to FIG. 3, the aggregation of a large volume of less popular items can add up to a significant amount of profit for an organization. Many businesses can earn profits by selling content items that are only of interest to smaller audience segments. These less popular content items may make up the long tail for such online businesses. Offering content items from the long tail enables customers to find, buy and refer content that they previously would not have discovered. In the same manner, V2P may leverage the long tail phenomenon for the video on demand market which will enable a strong business model for both the content owners and service providers with revenue from repeated viewing of these less popular shows. In addition, V2P rewards subscribers for sharing their STB resources.

V2P technology addresses a number of technical requirements, which the traditional streaming solutions cannot address: these include limited upstream bandwidth and resilience.

Currently, DSL and cable modem are two prevalent broadband technologies for household usage. Both have an asymmetric bandwidth property. That is, the downloading bandwidth is higher than the uploading bandwidth. In order to overcome the uploading bandwidth constraint for each STB, V2P uses multiple STBs as streaming sources and the receiving STB coordinates the streaming session from these multiple suppliers. Even as both uploading and downloading bandwidth increase, V2P may still be used to offer high quality and resilient streaming in both symmetric and asymmetric bandwidth environments.

Networks and devices are not yet perfect and, as such, resilience mechanisms need to be designed to cater for adverse conditions. As V2P streams over xDSL or cable modem connections and the network itself is unreliable, resilient streaming over network fluctuations is an issue for V2P. At any time STBs may be powered off, or the content can be deleted during a streaming session. To provide continuous and smooth streaming, V2P requires a very robust failure recovery mechanism. According to specific embodiments, V2P uses a combination of mechanisms such as intelligent peer selection, forward error correction (FEC) codes, dynamic rate distribution, dynamic buffer management, and network tomography-based connection monitoring to address unreliability of link as well as the devices and provide high quality streaming.

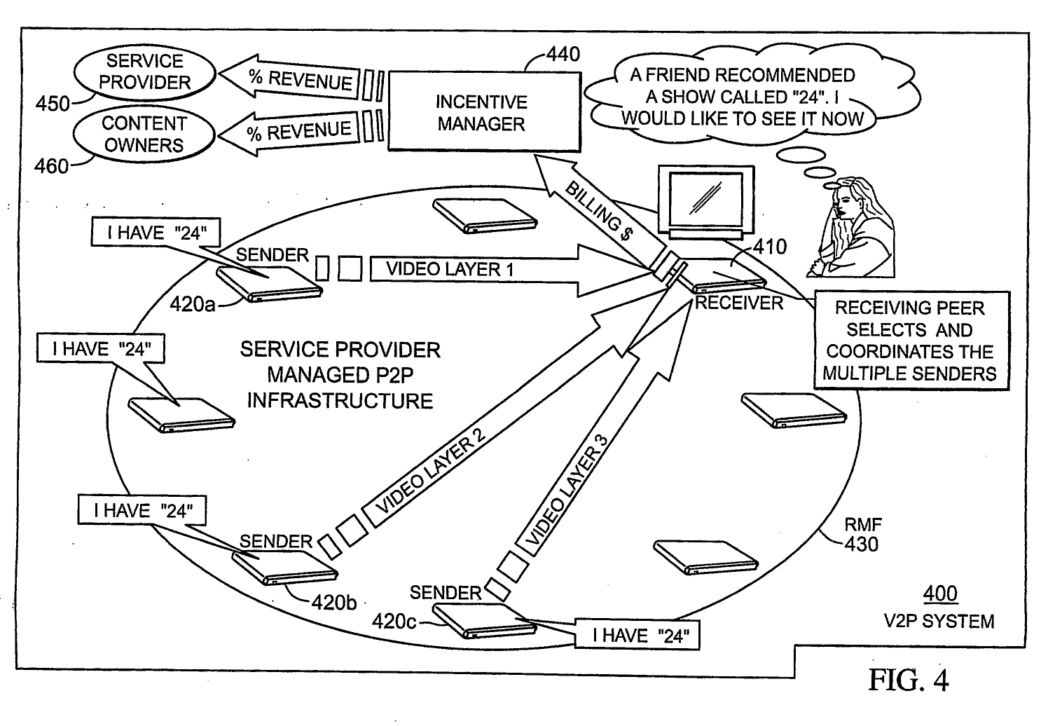

FIG. 4 illustrates an embodiment of a VoD-to-peer (V2P) system. As shown, a V2P system 400 comprises a receiver 410, senders 420a, 420b, and 420c, hereinafter identified as senders 420, a resource management framework (RMF) 430, and an incentive manager 440. Also shown in FIG. 4 are a service provider 450 and content owners 460. Receiver 410, shown here as a set top box (STB), is a receiving peer that receives streaming media from senders 420. Senders 420, shown here as set top boxes (STBs), are sending peers, or suppliers of streaming media. It should be noted that receiver 410 may at other times act as a sending peer. Similarly, any one of senders 420 may at other times act as a receiving peer. Resource management framework (RMF) 430 is a managed infrastructure, managed by a service provider, which manages the control and data connections between receiver 410 and senders 420 to perform on demand streaming of requested media. RMF 430 also allows receiver 410 to search V2P system 400 for streamable content, such as media files, downloaded and/or recorded and stored on senders 420. RMF 430 also allows a receiver 410 to receive content recommendations. Incentive manager 440 manages the accounting aspect of using a V2P system, including charging a receiver that receives particular content as streaming media, rewarding suppliers of streaming media, and rewarding the service provider 450 and content owners 460 for each streaming of content.

The V2P system illustrated in FIG. 4 is a multi-source streaming system. This means that every streaming session will comprise one receiver and a set of senders, or suppliers. One basic assumption is that each supplier has an identical copy of a media file corresponding to a given content item. In case the STBs of suppliers are not synchronized and their copies of a media file are not wholly identical, however, V2P according to a specific embodiment provides a mechanism for synchronizing the streaming media from multiple suppliers. This synchronization mechanism is described in detail later. V2P divides the media file into a set of small data blocks (e.g., suitable to play for 1-2 seconds) and each source supplies a fraction of the same block. Therefore, all suppliers contribute to each block of a file.

For example, according to a specific embodiment, each block of a media file may be encoded with a forward error correction (FEC) code to tolerate packet loss. An FEC encoding scheme is expressed with two parameters (n, k), and n packets are sent instead of k, with n>k, per data block. Any k out of n packets can reconstruct the block. Therefore, a streaming session can tolerate losing up to (n−k) packets per block. The FEC encoding overhead ratio α is defined as follows:

$$α = \frac{n - k}{n} .$$

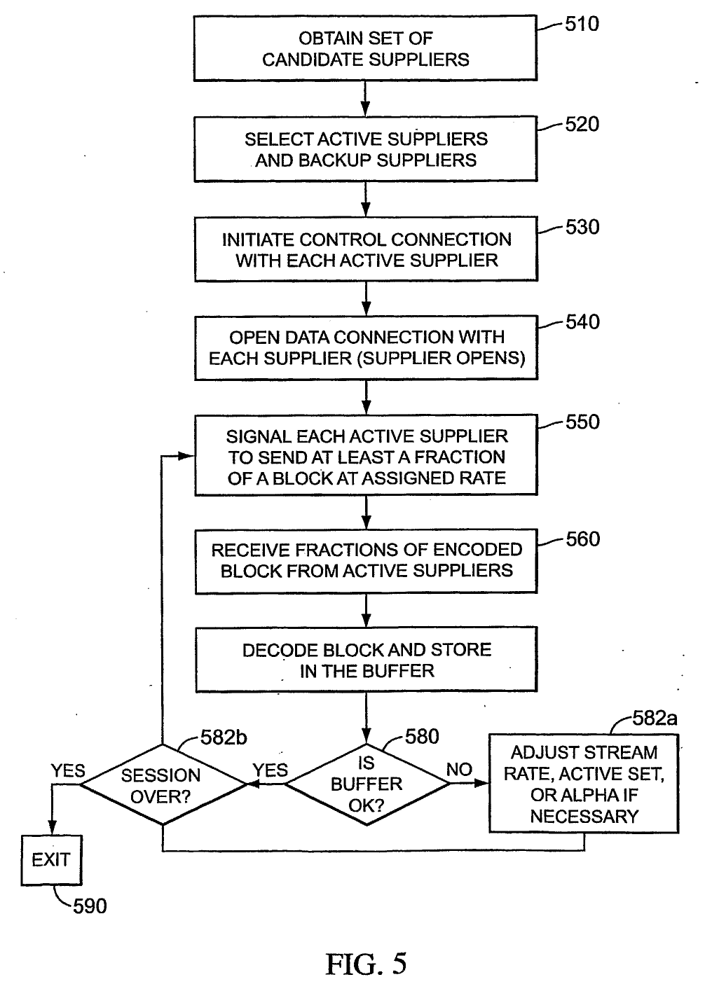

The FEC encoding overhead ratio and the encoding scheme impact the streaming rate and packet loss tolerance for a streaming session. Hence the FEC encoding overhead ratio can be established for the particular encoding scheme of a streaming session. In one instance, the FEC encoding overhead ratio is used to establish the encoding parameters to be used by the suppliers, and in another instance it can be used to signal the suppliers to select an FEC-encoded block of data that fits the particular encoding parameters. As an example, FIG. 5 is a flow diagram illustrating a method for performing a streaming session using a V2P system according to one embodiment of the invention. The streaming session is initiated by a receiver, which makes a streaming request for particular content such as a particular media file.

At step 510, the receiver obtains a set of candidate suppliers capable of supplying a requested media file. Candidate suppliers are peers that have a copy of the requested media file. For example, a receiver may use a search engine to search for particular content on the V2P system and obtain a set of candidate suppliers of the content.

At step 520, the receiver selects from the set of candidate suppliers a set of active suppliers and a set of backup suppliers. Active suppliers are peers acting in concert during a streaming session to stream the requested media file to the receiver. Backup suppliers are peers that may assist during the streaming session if one or more of the active suppliers experiences a network fluctuation, device failure, or content corruption or deletion. The receiver may select peers based on various criteria, for example, such as a peer's status, available uplink bandwidth, processing power, reliability history, path latency, and path packet loss ratio as well as fairness metrics.

At step 530, the receiver initiates a control connection with each active supplier. The receiver may use any one of a number of known techniques. For example, the receiver may send control packets using the transmission control protocol (TCP).

At step 540, each active supplier opens a data connection with the receiver. The receiver may receive streaming data from the suppliers using any one of a number of known techniques. For example, the receiver may receive streaming data using a user datagram protocol (UDP)-based scheme.

At step 550, the receiver requests fractions of the FEC-encoded block from each active supplier by signaling each active supplier to send at least a fraction of an FEC-encoded block at an assigned data rate. The aggregate of the assigned data rates represents the target streaming rate. Each active supplier sends part of an FEC-encoded block, which is FEC-encoded using a particular FEC encoding scheme having a particular FEC encoding overhead ratio. Each active supplier may FEC-encode a particular block using a particular FEC encoding overhead ratio α in response to receiving a signal from the receiver to send at least a fraction of an EEC-encoded block. Alternatively, each supplier may pre-encode a block using one or more FEC encoding overhead ratios, and may select a portion of a pre-encoded block in response to receiving a signal from the receiver.

At step 560, the receiver receives portions or segments of the FEC-encoded block. Due to network fluctuations, device failures, and content corruption or deletion, the receiver may not actually receive all of the requested fractions of the FEC-encoded block. The portions or segments that the receiver receives correspond to the fractions of the FEC-encoded block that the receiver requested at step 550. Based on the portions or segments actually received, the receiver passively monitors the performance of the connection with each active supplier to determine the actual received data rate. The aggregate of the actual received data rates represents the current streaming rate.

At step 570, the receiver decodes the block based on the received portions or segments of the encoded block and stores the decoded block in a buffer. It should be noted here that decoding the block may include reconstructing the FEC-encoded block from the received portions or segments, FEC decoding the reconstructed FEC-encoded block, and further decoding the FEC-decoded block according to the particular video encoding scheme (e.g., MPEG) utilized. The receiver consumes data for playback from the buffer at a current playing rate.

At step 580, the receiver checks the status of the buffer. The buffer status may be evaluated, for example, by monitoring the current size of the buffer, the current playing rate, and the current streaming rate. Depending on these metrics, the buffer may be operating in one of three zones: the speedup zone, the comfort zone, or the slowdown zone. If the buffer is operating in the comfort zone, for example, the receiver proceeds to step 582b and continues the streaming session. If the buffer is operating in the speedup zone or in the slowdown zone, the receiver proceeds to step 582a.

At step 582a, the receiver adjusts one or more of the streaming rate, the suppliers in the active set, and the encoding overhead ratio as needed to avoid a buffer overflow or underflow. If any suppliers are added to the set of active suppliers, steps 530 and 540 are performed.

At step 582b, the receiver performs a check to determine whether the streaming session is over. If the streaming session is over, the process exits at step 590. If the streaming session is not over, the process loops back to step 550.

An example of a streaming session in V2P may therefore comprise the following steps:
1. Initially, receiver peer P0 obtains a set of candidate suppliers from the search engine of the p2p network.
2. From the candidate set, P0 selects a set of peers P1, P2, . . . , PN as active suppliers and P1, P2, . . . , PM as backup suppliers.
3. P0 begins a streaming session by initiating a control connection to each supplier in the active set.
4. After receiving the control connection, each supplier Pi opens a data connection to receiver P0
5. P0 periodically signals each supplier to send a fraction of a particular block encoded with a specific α.
6. Each supplier Pi encodes the file block and sends a fraction of the file according to the assigned rate.
7. After receiving enough data for each block, P0 decodes the whole block and stores in the buffer. The player at the receiver side consumes data from the buffer.
P0 reacts to the network changes and device failures to ensure that there is always data in the buffer to feed the player and the buffer is not full to avoid buffer overflow. If necessary, P0 adds one or more backup peers to the active set and repeats steps 3-4 for any newly added peers.
P0 repeats steps 5-7 until the session is over.

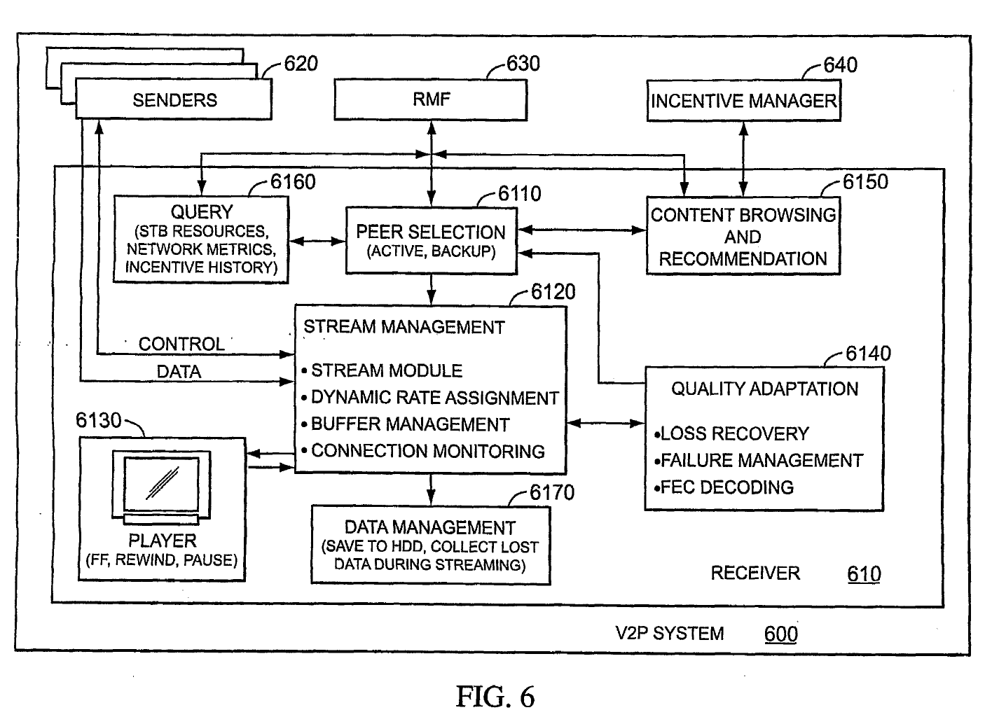

FIG. 6 is a block diagram of a V2P system, and further illustrates a receiver according to one embodiment of the present invention. In this embodiment, a V2P system 600 comprises a receiver 610, senders 620, a resource management framework (RMF) 630, and an incentive manager 640. Receiver 610 interacts with senders 620 to receive streaming data. Receiver 610 interacts with the RMF 630 to enable a user to search the p2p network. Receiver 610 interacts with the incentive manager 640 responsible for charging users and providing rewards to the appropriate entity.

According to FIG. 6, receiver 610 further comprises peer selection module 6110, stream management module 6120, interactivity management module (identified here as player module 6130), quality adaptation module 6140, content browsing and content recommendation module 6150, query module 6160, and data management module 6170.

Briefly, the peer selection module 6110 uses a peer selection process to select active and backup peers, or suppliers of streaming data of particular content. The stream management module 6120 manages the control and data connections with active suppliers, receives streaming data from the active suppliers, and decodes streaming data and stores it in a buffer. It also manages the buffer, dynamically distributes the streaming rate to each active supplier, monitors connections between the receiver and each active supplier, and manages interactive playback requests from a user. The interactivity management module 6130, identified here as player module 6130, provides interactive playback controls and interacts with the stream management module 6120 so that a user can pause, fast-forward, and fast-rewind during a streaming session. The quality adaptation module 6140 interacts with the stream management module 6120 and the peer selection module 6110 to provide resilient and high quality streaming in cases of network fluctuation, active supplier failures, and content corruption or deletion. In some cases, the quality adaptation module 6140 may require active suppliers to resubmit streaming data in order to cope with such situations.

The content browsing and content recommendation module 6150 interacts with the RMF 630 to allow a user to search for particular content, and also provides content recommendations to a user, according to specific embodiments. The query module 6160 interacts with the RMF 630 and the peer selection module 6110 to obtain information about remote peers. The data management module 6170 manages the storing of received streaming data on the receiver's local storage. Each of these modules is described in turn.

The peer selection module 6110 uses a peer selection process to determine a set of active peers and a set of backup peers. The active peers supply the content of a streaming session. The backup peers may become active during failure of any STB as well as during network fluctuation when the current active peers are unable to serve the target streaming rate. Backup peers may also become active if one or more active peers deletes the content or experiences content corruption during a streaming session.

In this embodiment, peer selection is done in two steps. In the first step, RMF 630 returns a set of candidate suppliers who have the content to stream. The size of a typical candidate set is 15-20 peers. If more copies of a media file are found in the network, this selection process eliminates the peers that have limited resources. After getting a candidate set from the RMF 630, the peer selection module 6110 determines the active and backup set based on various criteria. For example, the following peer status, bandwidth, device specifications, reliability, latency, loss ratio, and fairness criteria may be used:
1. Peer status (S)
   The status of a peer can be considered during peer selection. If a peer is receiving a stream, the uplink might be unused. However, if a receiving peer decides to serve another streaming session and the uplink is fully used for this serving, the receiving streaming quality will deteriorate because the signaling protocol uses the a small fraction of the uplink. Therefore, it is desirable to use an idle peer as a supplier. During SERVING or RECEIVING status of a peer, the peer selection module assigns Sᵢ=αᵢ for peer i, where α is computed based on available resources. Usually, Sᵢ=1 when the peer is IDLE and it has resources to serve.
2. Available uplink bandwidth of a supplier (B)
   It is undesirable to use too many or too few peers for a streaming session. If too many suppliers are used, the receiver has to maintain a lot of connections. If one or two suppliers are used, failure of one supplier will have high impact on the streaming quality. If the streaming rate is R₀, the peer selection module assigns Bᵢ=1 if peer i can supply ≧R₀/3, Bᵢ=0.75 if peer i can supply ≧R₀/4, and so on.
3. CPU, memory specs (C)
   If an STB has reasonable CPU and memory specs, the peer selection module can accept the peer. The peer selection module assigns Cᵢ=1 if peer i has CPU 400 MHz or higher and RAM is 128 MB or higher provided that the peer status is not SERVING or RECEIVING. Cᵢ=0 if the STB does not have enough resources to participate in a streaming session.
4. Reliability history (H)
   The reliability history H represents the reliability of the STB, which can be powered off at any time. The content of an STB can be deleted during a streaming session. Therefore, the reliability history of an STB has a significant impact on providing resilient streaming. The peer selection module assigns a value from 0 to 1 to the reliability metric.
5. Latency of the path from a supplier to the receiver (D)
   Latency, or one-way delay, can be used to decide how far a supplier is from a receiver. Even if a supplier has very good resources but the peer is located at other side of the world, it may not provide streaming at a steady rate. If there are suppliers in the same subnet of the receiver or in the same geographical location where the receiver resides, usually the latency is really low and these suppliers will get preference over the one who reside far away from the receiver. The peer selection module assigns Dᵢ=1 if peer i is less than 50 ms round trip time (RTT) away, Dᵢ=0.5 if peer i is less than 100 ms RTT away, Dᵢ=0 if peer i is more than 200 ms away.
6. Packet loss ratio of the path (L)
   Packet loss ratio represents the reliability of the network. The range of loss ratio is 0<L<1.
7. Fairness (F)
   The primary concern of peer selection mechanism is the quality of the streaming, and therefore, it selects the best set of peers for a streaming session that are suitable for a receiver. However, if more peers are available with similar quality (in terms of their resources, reliability, and other peer selection criteria), priority might be given to the peers that were not selected frequently comparing to others.

Based on the criteria above, the peer selection module may calculate the rank of each peer. If Rᵢ represents the rank of peer i, Rᵢ may be expressed as:

Rᵢ=CᵢSᵢ(BᵢDᵢ)Hᵢ(1−Lᵢ).

The peer selection process selects the top N+M peers based on their rank. If several peers have (N+M)th rank, the peer selection process select peers with low fairness index (F) so that every subscriber gets a chance to serve content items and earn rewards from the system.

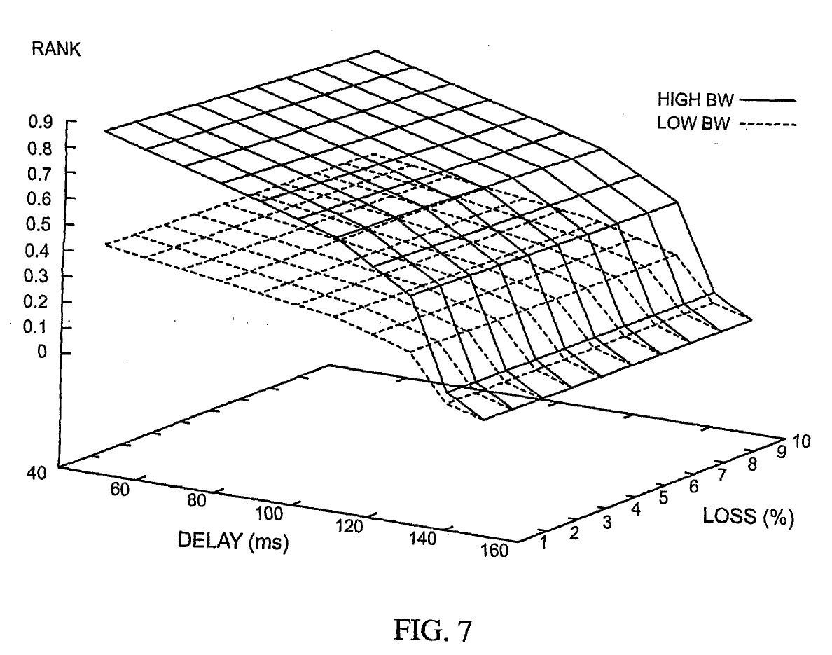

FIG. 7 is a graph of a peer selection rank equation and illustrates how the rank of a peer may change according to the peer selection criteria used. For example, FIG. 7 plots the rank of high bandwidth peers (e.g., uplink bandwidth of 384 Kbps or higher) and low bandwidth peers (e.g., uplink bandwidth of 128 Kbps or higher) versus delay and loss metrics. As illustrated, a high bandwidth peer that is located far away from the receiver may have a lower rank as compared to a low bandwidth peer located closer to the receiver.

During a search for content in a network, the resource management framework (RMF) 630 (FIG. 6) may return a long list of peers who have the content. It may not be feasible to apply the peer selection algorithm to the entire list of the search results. It may be more efficient, for example, to filter the initial list by discarding the peers who are busy with serving or peers having low uplink capacity or peers who are far away in geographical locations. From the filtered list, a set of, say, 15-20 peers would be used for conducting the peer selection algorithm and the selection sequence would be based on uplink capacity and geographical locations. Measurements that are necessary for peer selection may be performed during the initial buffering time with real media data. For example, during the first 10 seconds each peer may contribute a part of a media file to determine the quality of a supplier.

TABLE 1
Symbols, their meanings, and typical values that are used in peer
selection.

| Symbol | Explanation | Typical value |
|---|---|---|
| R₀ | Target streaming rate | 1.1 Mbps (Video + Audio) |
| R^{o}ᵢ | Offered rate by peer i | 128 Kbps, 256 Kbps, 384 Kbps |
| B | Capacity utilization | 0.8-0.9 |
| K | Number of packets before | 150 |
| | FEC encoding | |
| N | Number of packets after FEC | 180 |
| | encoding | |
| A | FEC overhead | 0.2 |
| Rᵢ | Rate receiving from peer i | βR^{o}ᵢ |
| R | Aggregated streaming rate | ≦R₀(1 + α) |
| N | Active suppliers | 6-10 |
| M | Backup suppliers | 2 |

To determine how many active peers are required for a streaming session, the peer selection module may use the following estimation:

$$Aggregate streaming rate , R = {\sum }_{i = 1}^{N} {R}_{i} = {\sum }_{i = 1}^{N} β {R}_{i}^{o} \leq {R}_{0} ( 1 + α )$$

where target streaming rate=R₀
number of active peers=N
offered rate by peer i=R^{o}ᵢ
initial streaming rate from peer i, Rᵢ=βR^{o}ᵢ (where, β is capacity utilization. 0<β≦1 so that peer i operates under 100% capacity utilization)
FEC overhead=α
packet loss tolerance with FEC=α/(1+α).

As an example, if the streaming rate is 1.1 Mbps, with α=0.20 FEC, the required streaming rate is 1.32 Mbps. Let each peer have uplink streaming bandwidth R^{o}ᵢ=256 Kbps. Rᵢ=248 when β=0.8. Therefore, N=7, and the peer selection module may select 5-7 active peers based on their outgoing bandwidth.

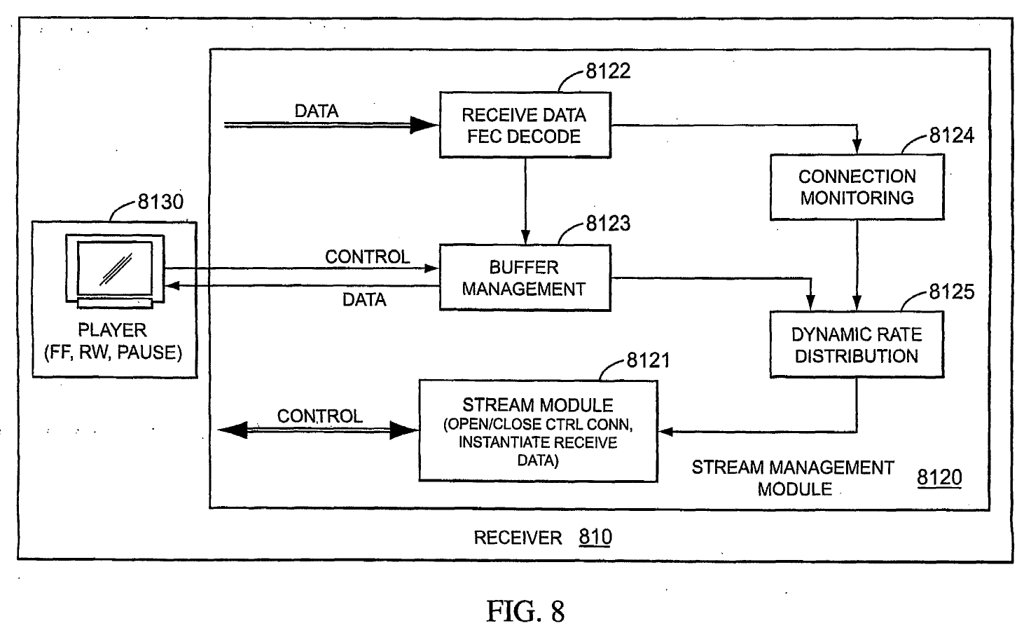

Referring again to FIG. 6 and with reference to FIG. 8, the stream management module 6120 according to a specific embodiment is described. FIG. 8 is a block diagram of a V2P receiver and includes details of a stream management module according to one embodiment of the present invention. According to FIG. 8, a receiver 810 comprises a stream management module 8120 and a player module 8130. According to a specific embodiment, the stream management module 8120 comprises a stream module 8120, a receive data module 8122 (identified here as receive data/FEC decode module 8122), a buffer management module 8123, a connection monitoring module 8124, and a dynamic rate distribution module 8125.

In operation, the stream module 8121 opens and closes control and data connections to all active suppliers and sends control packets to active suppliers instructing which portions of data blocks to send at what data rate. The receive data module 8122, identified here as receive data/FEC decode module 8122, receives streaming data from active suppliers, decodes the streaming data, and passes it to the buffer management module 8123. The buffer management module 8123 receives decoded streaming data from the receive data module 8122, interacts with a player module 8130 to allow a user to pause, fast-forward and fast-rewind, and manages the buffer and interacts with the dynamic rate distribution module 8125 to ensure that the buffer is not full and not empty. The connection monitoring module 8124 monitors the connections between active suppliers and the receiver to determine whether any connection is experiencing congestion or whether any supplier fails, and interacts with the dynamic rate distribution module 8125 in case of network fluctuations and device failures. The dynamic rate distribution module 8125 interacts with the buffer management module 8123 and the connection monitoring module 8124 and dynamically distributes the streaming rate to active suppliers in order to cope with network fluctuations and device failures.

The stream module 8121 opens and closes control and data connections to all active suppliers. The stream module 8121 establishes communication to all supplying peers in the active set by opening one control connection to each supplier, and ideally, the control connection is expected to be reliable. For example, the transmission control protocol (TCP) may be used. The stream module 8121 also signals each supplier with control information for establishing a data path to the receiver. The stream module 8121 also sends control packets to active suppliers instructing which portions of data blocks to send at what data rate, which constitutes dynamic rate distribution of the streaming rate among the active suppliers. The control packet indicates a fraction of a block to send and a data rate. The rate distribution comes from the dynamic rate distribution module 8125.

The receive data module 8122, identified here as receive data/FEC decode module 8122, receives streaming data from active suppliers, decodes the streaming data, and passes it to the buffer management module 8123. The receive data module 8122 is instantiated by the stream module 8121 to receive data from all active suppliers, and the active suppliers establish a data path to this module. Note that V2P may use a protocol such as the user datagram protocol (UDP) for data streaming, according to a specific embodiment. Alternatively, V2P may use any UDP-based congestion control protocol such as Datagram Congestion Control Protocol (DCCP) or the like in other embodiments. Upon receiving the streaming data, the receive data module 8122 decodes the streaming data before handing it over to the buffer management module 8123. It should be noted that decoding the block may include reconstructing the FEC-encoded block from the received portions or segments, FEC decoding the reconstructed FEC-encoded block, and further decoding the FEC-decoded block according to the particular video encoding scheme (e.g., MPEG) utilized.

The buffer management module 8123 receives decoded streaming data from the receive data module 8122, interacts with a player module 8130 to allow a user to pause, fast-forward, and fast-rewind. It also manages the buffer and interacts with the dynamic rate distribution module 8125 to ensure that the buffer is not full and not empty. For example, when a user presses a button to pause a streaming session, the buffer management module 8123 interacts with the dynamic rate distribution module 8125 to adjust the streaming rate. The buffer management module also ensures that there is always data in the buffer to playback media data. For example, the playback may begin after short initial buffering time (e.g., 10 seconds) or a short advertisement. After that, the buffer management module 8123 periodically estimates whether with the current playing rate and streaming rate, the buffer will not be empty or overflow in near future. If necessary, the streaming rate may be adjusted accordingly by the dynamic rate distribution module 8125.

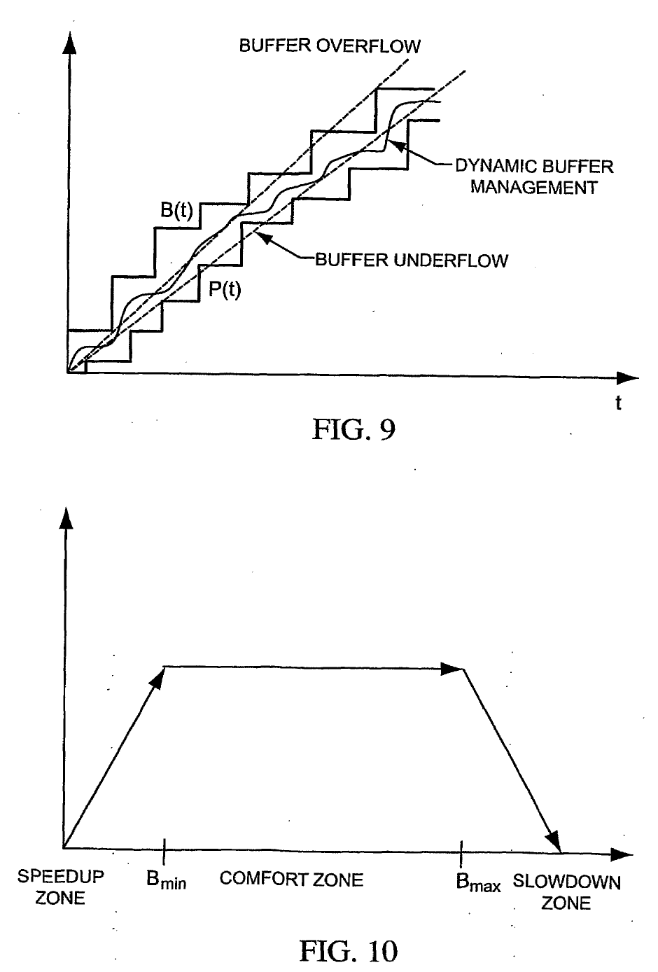

FIG. 9 presents a graph illustrating how a dynamic buffer management technique can avoid a buffer overflow or underflow according to one embodiment of the present invention. In this graph, B(t) represents the maximum cumulative data that can be stored in the buffer and P(t) represents the cumulative data consumed by the player at time t. As can be seen, a constant bit rate (CBR) streaming rate can easily cause buffer overflow or underflow. A dynamic buffer management algorithm avoids these scenarios by periodically adjusting the streaming rate.

For example, a constant bit rate (CBR) streaming rate cannot ensure that the buffer will not overflow or become empty in future because the network condition changes and the peers can fail at any time. Therefore, a dynamic buffer management technique may be used that adjusts the streaming rate based a number of parameters, which in this instance include:
a) current buffer size,
b) current playing rate, and
c) current streaming rate.

FIG. 10 presents a graph illustrating a buffer management scheme according to one embodiment of the present invention. As shown, the buffer is partitioned into three parts: Speedup Zone (0<buffersize<Bₘᵢₙ), Comfort Zone (Bₘᵢₙ<buffersize<Bₘₐₓ), and Slowdown Zone (buffersize>Bₘₐₓ). The values of Bₘᵢₙ and Bₘₐₓ depend on the allowable buffer size in a system. For example, if a system can have 30 seconds of buffering, Bₘᵢₙ=10 sec and Bₘᵢₙ=20 sec can be an option. The streaming rate is adjusted based on the current buffer size and the change of buffer, which is calculated using current streaming rate and playing rate. If the current buffer size is below Bₘᵢₙ and change of buffer size is negative, the stream rate is increased. The stream rate is not changed in the comfort zone. If the buffer size is above Bₘₐₓ, the stream rate is decreased.

In order to compute the rate to adjust the current streaming rate, the buffer management module 8120 uses the Exponential Weighted Moving Average (EWMA) of the instantaneous streaming rate. In general, EWMA is expressed as in the following equation:

R_{avg}(t)=wR(t)+(1−w)R_{avg}(t−1),

where 0<w<1 is constant to put a weight on the current instantaneous sample or the recent history.

For example, the buffer management module defines w for each zone of the buffer size. When the buffer is operating in the speedup zone, to adjust the streaming rate the instantaneous streaming rate must be emphasized. Therefore, a higher weight is given to w in this zone. When the buffer is operating in the comfort zone, a lower weight is given to w to compute a smooth streaming rate that can be used to adjust streaming rate in the slowdown zone. In the slowdown zone, a high weight is given to a to slow down the streaming rate more aggressively.

Referring again to FIG. 8, the connection monitoring module 8124 monitors the connections between active suppliers and the receiver to determine whether any connection is experiencing congestion or whether any supplier fails, and interacts with the dynamic rate distribution module 8125 in case of network fluctuations and device failures. Connection monitoring is a useful mechanism to determine whether any data path from a supplier to the receiver is experiencing congestion or whether any peer fails. For example, if the receiver does not receive any data from a given peer for a specific time frame, it assumes that the peer is no longer alive.

It may be relatively hard to pinpoint the location of network congestion. If the location of network congestion is known, the quality adaptation module (item 6140 of FIG. 6) can decide how to treat each connection between a supplier and the receiver. For example, if only one connection is affected by the network congestion, other connections can provide data at a higher rate to overcome this. However, if most of the connections experience congestion at the same time, it might be necessary to add peers from the backup set so that additional streaming from these peers can mitigate the effect of congestion.

The connection monitoring module 8124 can use the network tomography technique to identify the path segments that experience congestion. The basic idea of network tomography involves using packet “stripes” (i.e., back-to-back probe packets) to infer link loss by computing the correlation of packet loss within a stripe at the destinations. To infer loss, a series of probe packets called a stripe is sent from one node to two other nodes with zero transmissions delay. If a packet reaches any receiver, it can be inferred that the packet must have reached the branch point. Based on the number of packets reached at the end hosts, it is possible to calculate the probability of the successful transmission probability for all of the internal links.

The connection monitoring module 8124 monitors connections passively. That is, there is no active probing during streaming. The connection monitoring module 8124 uses the streaming data. The data comes from the suppliers to the receiver rather than from one source to multiple receivers as in some network tomography techniques.

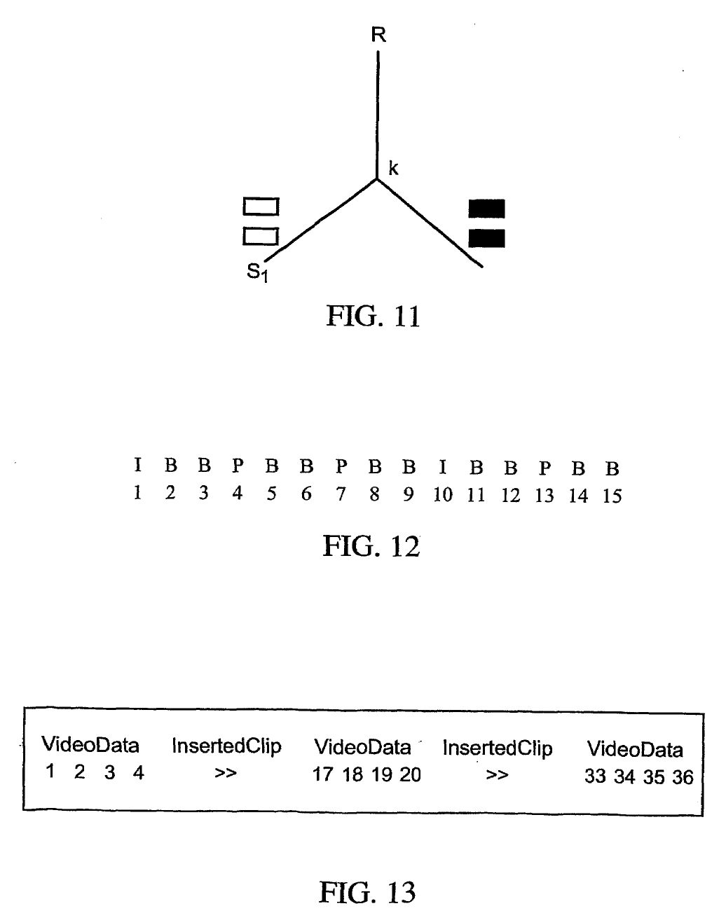

It may be necessary to conduct experiments to estimate the proper size of a stripe and how to divide the packet between the suppliers so that receiver can capture the correlation of packet loss on the shared as well as the individual paths. It is possible to estimate the characteristics of the paths from the suppliers to a receiver. FIG. 11 illustrates a simple binary tree from two suppliers S1 and S2 to a receiver R. As the suppliers are synchronized with time to send packets of a block, it is highly likely that packets from S₁ and S₂ will experience similar congestion in the shared path segment k→R. A stripe of D packets D=<D₁, D₂> may be used, where S₁ sends D₁ packets and S₂ sends D₂ packets. If R gets all packets of a stripe from S₁, it is highly like that R will receive D₂ packets from S₂ unless they are lost on S₂→k.

Referring again to FIG. 8, the dynamic rate distribution module 8125 interacts with the buffer management module 8123 and the connection monitoring module 8124 and dynamically distributes the streaming rate to active suppliers in order to cope with network fluctuations due to congestion and device failures.

The dynamic rate distribution module 8125 allows changing the current streaming rate at any time. The stream module 8121 sends a control signal to each active supplier at each time frame to specify the new rate. The connection monitoring module 8124 determines which connection is experiencing congestion, the buffer management module 8123 determines what should be the current streaming rate, and the rate distribution module 8125 determines the rate at which each supplier should stream at time t. Then, it signals the stream module 8121 to send control packets to each supplier with the new rate and the index of the file segment a supplier should send in the next time frame.

According to FIG. 8, the interactivity management module, identified here as player module 8130, is described according to a specific embodiment. The player module 8130 provides interactivity so that a user can pause, fast-forward (FF), and fast-rewind (RW) a streaming session. During each of these events as described in more detail below, the player module 6130 informs the buffer management module 8123 which takes appropriate action based on the event.

We start with the pause control description. When a user pushes a button to pause a streaming session, the buffer management module 8123 signals the dynamic rate distribution module 8125 to distribute a new streaming rate, for example 0 Kbps. The dynamic rate distribution module 8125 signals the stream module 8121 to pause the streaming session. The stream module 8121 sends a control signal to each active supplier and the streaming session is paused until it is resumed or a pause timer expires. While the streaming session is paused, the receiver does not request any additional streaming data from the active suppliers. When the streaming session is resumed, the stream module 8121 sends a control signal to each active supplier to resume the streaming session. If the pause timer expires, the streaming session will be closed.

Turning to the fast-forward (FF) and fast-rewind (RW) control, if a receiver has local storage such as a hard disk, the RW operation is performed from already saved content. Otherwise, both RW and FF can be implemented in a similar fashion. A number of approaches can be associated with the FF operation. The first one uses a separate interactive stream to provide VCR-like smooth interactivity; however, the cost is that a separate interactive stream for each media file is required. The second one is a solution that does not use an additional stream and achieves fast-forward or fast-rewind with a seeking mechanism.

In particular, when using an interactive stream, the FF operation requires a separate stream (i.e., interactive stream) and a separate buffer (i.e., interactive buffer). For the fast-rewind operation, the interactive stream is formed in a reverse order from the playback stream. A separate interactive stream is required because during fast-forward and fast-rewind, the suppliers have to send only a subset of the stream and not the original stream. Without a separate interactive stream, the suppliers would have to decode the stream and send the appropriate frames of interest. It might not be possible to achieve that in real time. Therefore, this technique utilizes a separate stream with the frames that can achieve the target FF or RW speed. For example, to achieve a speed up factor of X, the player needs one out of X frames. However, in MPEG terminology, a B frame cannot be decoded without an I and/or P frame and a P frame cannot be decoded without a preceding I or P frame. Therefore, sending one out of X frames is not enough for a fast-forward event.

FIG. 12 illustrates a sequence of MPEG frames of a streaming session. In order to gain a speed up factor of 5, the suppliers need to send I, (P, B, B, P), (I, B, B, P), etc. This is because a B frame needs both of its neighboring frames to decode and a P frame also need a preceding I or P frame. Thus, more than ⅕ of the frames need to be sent by the suppliers to speed up the stream 5 times. Therefore, this process increases the streaming data rate during FF and RW, while it may not be possible to increase the streaming rate in a DSL-based network, where the downlink speed is often only sufficient for the normal streaming rate.

In order to maintain a lower data rate during FF and RW, an interactive stream can be used, according to a specific embodiment. An interactive stream can be created in the following way. The original video material needs to be sub-sampled before compression. For an X time fast-forward speed, every X-th video frame would be stored to a suitable device before MPEG encoding. For example, to achieve a 4× fast-forward speed, every 4th video frame is used. This content would then be MPEG encoded in the normal fashion and stored in a separate file. This method results in very high quality FF viewing with very smooth motion, but it requires intermediate storage of the sub-sampled uncompressed video.

In order to avoid the additional work of sub-sampling preprocessing and intermediate storage, FF may be achieved in the MPEG compressed domain, according to a specific embodiment. Each sender dynamically transcodes the I frames to meet the requirements during FF and then wrapped in a Sequence Header to create a GOP (Group of Pictures) with only one I frame. In order to implement such a scheme, each sender must be computationally capable to transcode I frames on demand.

Returning again, to FIG. 8, to provide interactivity, the buffer management module 8123 needs to maintain two buffers: one for the regular stream and one for the interactive stream. During regular playback, the buffer management module 8123 puts only the I-frames in the interactive buffer so that if a user selects FF or RW, player module 8130 immediately receives data from the interactive buffer. The buffer management module 8123 feeds the player from the interactive buffer until the user comes back to normal play mode. The stream module 8121 sends a control signal to each supplier to send data from the interactive stream during this time. Each supplier will send one I frame so that N I-frame is ready in the interactive buffer. It will allow the user to fast-forward from one I frame to the next. If the interactive buffer is out of data, the player module 8130 will not allow the user to FF/RW and will resume normal play. When the user resumes normal play, the buffer management module 8123 feeds the player module 8130 data from the regular buffer. If the regular buffer does not have enough data for normal play, it can play the sub-sampled data for a few seconds until the regular buffer has enough data to play at a full rate.

In the alternative approach to simulating the FF and RW operations, file seeking is used to avoid the requirement of having a separate interactive stream, according to a specific embodiment. In particular, when a user presses FF or RW button, the player module 8130 plays X seconds of video data and then jumps Y seconds to an appropriate position in the file to achieve speed up. All the suppliers will supply the video data corresponding to the X seconds and then seek Y seconds in the file to fetch the next video data.

According to a specific embodiment, a variable speed up can be achieved by setting the values of X and Y, and a speed up actor can be calculated as follows:

$$Speed Up Factor = \frac{Total\_Stream \_Play \_Time}{Playout\_time} = \frac{X + Y}{X} .$$

For example, if X=2 seconds and Y=6 seconds, the speed up factor is 4.

If player module 8130 plays video data at a normal speed, the temporal position in the streaming data will advance because of the jump but the user won't perceive the speed up factor. Therefore the player module 8130 plays the video data at a higher speed than the normal speed. If the suppliers continue to send streaming data at a regular streaming rate, since it may not be possible for them to speed up, for example, in a DSL network, the buffer may become empty because of the higher playing rate. In order to overcome this, the player module 8130 may play a short video clip that is stored locally on the receiver. The short video clip may be inserted into the buffer between blocks of streaming data. For example, the inserted video clip can be an animated “>>” or “<<” based on FF or RW event. Such a short animated video clip may inform the viewer that the system is performing some processing. The clips may be generated beforehand and stored at the receiver side so that there is no need to stream these clips.

FIG. 13 illustrates a series of video data and inserted video clips. As shown, the player module 8130 plays 4 seconds of video followed by an inserted video clip, jumps 12 seconds and plays 4 seconds of video data followed by an inserted video clip, jumps another 12 seconds and plays 4 seconds of video data. The player module plays the video data and the video clips at twice the normal speed. In this example, if X=4, Y=12, and the length of the inserted video clip is equal to X=4, then the speed up factor is given by the relationship

$$Speed Up Factor = \frac{X + Y}{Play\_ 2 X\_data \_at \_ 2 x\_speed} = \frac{X + Y}{X} = 4.$$

One aspect of the present invention used for improving the quality of data streaming for receiving broadband data as described above involves quality adaptation (using quality adaptation module 6140 as shown in FIG. 6 and with reference to stream management module 8120 as shown in FIG. 8). Quality adaptation is an important component for providing resilient and high quality streaming. The streaming quality degrades during network fluctuations and device failures. To deal with both issues, V2P uses mechanisms such as the following:
a) intelligent buffer management,
b) connection monitoring,
c) dynamic rate distribution,
d) dynamic FEC encoding/decoding,
e) active peer selection (N active peers), and
f) backup peer selection (M backup peers).
   The first two mechanisms are used to detect the failure conditions and identify the actual location of congestion. The last four mechanisms are used to deal with network fluctuations and device failure. Each of these two scenarios is described. In some cases, the quality adaptation module 6140 may require active suppliers to resubmit streaming data in order to cope with such situations.

The quality adaptation process for coping with network fluctuations is described, according to a specific embodiment. The Internet is a best-effort service, and network layer metrics such as latency, loss, and jitter of any end-to-end path may change over time. The connection monitoring mechanism can identify the actual location of network congestion. For example, let, K connections experience quality degradation at any time. First, the quality adaptation module 6140 checks whether the aggregate streaming rate still meets the target streaming rate. If this is not satisfied, the streaming rate is redistributed so that active suppliers with good network conditions supply more to adjust the rate not supplied by the other active suppliers. Such dynamic rate redistribution is possible because the active peer selection is done in such a way that the active suppliers stream at a rate lower than their full capacity. The left over capacity may be utilized for dynamic redistribution of the streaming rate from each active supplier. If the active suppliers cannot provide the target streaming rate, the quality adaptation module 6140 may direct the peer selection module 6110 to add one or more backup peers to the active set. After adding all backups, if the active suppliers still cannot meet the target streaming rate due to high packet losses, the quality adaptation module 6140 may direct the stream management module 6120 to increase the F EC encoding overhead ratio (α) based on the current loss rate. For example, when α=0.20 and the current loss ratio is 35%, then the new value of α will be adjusted to match the loss ratio to sustain with future changes. If the loss ratio goes down after a while, the adaptation module will reduce the value of α accordingly.

For example, the following illustrates an algorithm (Algorithm 1) which the quality adaptation module 6140 may use for adjusting streaming rates, adding backup peers, and adjusting an encoding overhead ratio α to cope with network fluctuation. The illustrated algorithm uses a δ to ensure that the current streaming rate is slightly higher than the target streaming rate R₀ otherwise with little network fluctuation, the streaming quality will deteriorate. If Raptor codes are use, δ will express the extra data necessary for Raptor decoding because this code requires 5% more data than the original content to decode.

Algorithm 1 for a network fluctuation:

| | |
|---|---|
| 1. | identify K connections experiencing congestion at time t |
| 2. | if ${\sum }_{i = 1}^{N} {R}_{i} - {R}_{0} \geq δ ,$ do nothing//good standing with current rate |
| 3. | else if ${\sum }_{i = 1}^{K} {R}_{i} + {\sum }_{i = K + 1}^{N} {R}_{i}^{o} - {R}_{0} \geq δ ,$ redistribute the stream rate to (N-K) goodpeers to meet the target rate. |
| 4. | else add a backup peer to the active set. goto step 3. |
| | if no backup is available goto step 5 |
| 5. | adjust α to adjust packet loss in the network. Add more backup |

In this algorithm according to a specific embodiment, at step 1, a connection monitoring module (such as connection monitoring module 8124 of FIG. 8) of a stream management module 6120 monitors the N connections with N active suppliers and identifies K connections experiencing congestion at time t. At step 2, if the current aggregate streaming rate (i.e., the sum of all Rᵢ) exceeds the target streaming rate R₀ by at least δ, that is, if

$${\sum }_{i = 1}^{N} {R}_{i} - {R}_{0} \geq δ ,$$

then the current streaming rate is sufficient and the quality adaptation module 6140 does nothing. Otherwise, the quality adaptation module 6140 attempts to redistribute the streaming rate among the (N−K) “good” peers in the active set not experiencing congestion at step 3.

Since these (N−K) “good” peers initially stream at a rate lower than their full capacity, the left over capacity of these (N−K) “good” peers may be utilized to achieve the target streaming rate R₀. That is, each of the (N−K) “good peers” may stream at a rate up to its full capacity R^{o}ᵢ. Thus if the current aggregate streaming rate for the K peers experiencing congestion (i.e., the sum of all Rᵢ for these K peers) plus the full capacity of the (N−K) “good peers” (i.e., the sum of all R^{o}ᵢ for these (N−K) peers) exceeds the target streaming rate R₀ by at least δ, that is, if

$${\sum }_{i = 1}^{K} {R}_{i} + {\sum }_{i = K + 1}^{N} {R}_{i}^{O} - {R}_{0} \geq δ ,$$

then the quality adaptation module 6140 directs the stream management module 6120 (e.g., through a dynamic rate distribution module) to redistribute the streaming rate to the (N−K) good peers in order to meet the target streaming rate. Otherwise, at step 4 the quality adaptation module directs the peer selection module 6110 to add a backup peers to the set of active peers, so that there is an updated number N of active suppliers.

The algorithm loops back to step 3 and the quality adaptation module 6140 directs the stream management module 6120 (e.g., through a dynamic rate distribution module) to redistribute the streaming rate to the (N−K) good peers in order to meet the target streaming rate. If at step 4 there are no backup peers available, then the quality adaptation module 6140 adjusts the encoding overhead ratio α to adjust packet loss in the network. The quality adaptation module 6140 also directs the peer selection module 6110 to select additional peers to add to the set of backup peers.

Another aspect is the quality adaptation process for coping with a device failure. In particular according to a specific embodiment, a streaming session starts with N active peers and each peer has β capacity utilization. V2P selects β in such a way that if one of the peers (i.e., one of the STBs) fails, the streaming rate can be immediately redistributed to the rest of the peers in the active set without exceeding their uploading capacity limit. Therefore, if one peer fails at any time, the streaming rate is distributed over the rest of the active suppliers and the aggregate streaming rate does not go below the target rate. If two or more peers fail concurrently, the quality adaptation module may add backup peers to the set of active suppliers.

For example, the following illustrates an algorithm (Algorithm 2) according to a specific embodiment, which the quality adaptation module may use for adjusting streaming rates, adding backup peers, and adjusting an encoding overhead ratio α to cope with device failure. When K devices (i.e., STBs) fail, the quality adaptation module 6140 directs the stream management module 6120 (through a dynamic rate distribution module) to redistribute the streaming rate among the rest of the suppliers in the active set. The quality adaptation module 6140 also directs the peer selection module 6110 to add a backup peer to the set of active suppliers in order to cope with the next device failure. If the rest of the suppliers in the active set cannot provide the target rate and the network is not experiencing high loss, the quality adaptation module 6140 directs the stream management module 6120 to reduce the FEC encoding overhead ratio α to adjust with current loss ratio. If more suppliers are necessary, the quality adaptation module 6140 directs the peer selection module 6110 to additional suppliers to the set of backups. Since a buffer management module typically maintains 5-10 seconds of decoded data available for the player module, this time allows the quality adaptation module 6140 to add more backup suppliers to the active set in order to meet the target streaming rate.

Algorithm 2 for STB failure:

| | |
|---|---|
| 1. | identify K failed STBs |
| 2. | if ${\sum }_{i = K + 1}^{N} {R}_{i} - {R}_{0} \geq δ ,$ do nothing//good standing with current rate |
| 3. | else if ${\sum }_{i = K + 1}^{N} {R}_{i}^{o} - {R}_{0} \geq δ ,$ redistribute the stream rate to (N-K) peers in the active set.Add a backup to the active set to cop with next failure. |
| 4. | else |

| | |
|---|---|
| a. | add a backup peer to the active set. |
| | If no backup is available adjust α, if necessary |
| b. | redistribute the streaming rate to the active set |
| c. | find a backup peer and add to the backup set |
| d. | goto step 4a. |

As shown above, at step 1 a connection monitoring module identifies K failed STBs. At step 2, if the current aggregate streaming rate (i.e., the sum of all Rᵢ) of the remaining suppliers in the active set exceeds the target streaming rate R₀ by at least δ, that is, if

$${\sum }_{i = K + 1}^{N} {R}_{i} - {R}_{0} \geq δ ,$$

then the current streaming rate is sufficient and the quality adaptation module 6140 does nothing. Otherwise, the quality adaptation module 6140 attempts to redistribute the streaming rate among the (N−K) “good” peers in the active set that have not failed at step 3. Since these (N−K) “good” peers initially stream at a rate lower than their full capacity, the left over capacity of these (N−K) “good” peers may be utilized to achieve the target streaming rate R₀. That is, each of the (N−K) “good peers” may stream at a rate up to its full capacity R^{o}ᵢ. Thus if the full capacity of the (N−K) “good peers” (i.e., the sum of all R^{o}ᵢ for these (N−K) peers) exceeds the target streaming rate R₀ by at least δ, that is, if

$${\sum }_{i = K + 1}^{N} {R}_{i}^{O} - {R}_{0} \geq δ ,$$

then the quality adaptation module 6140 directs the stream management module 6120 (through a dynamic rate distribution module) to redistribute the streaming rate to the (N−K) good peers in order to meet the target streaming rate. The quality adaptation module 6140 directs the peer selection module 6110 to add a backup peer to the active set.

Otherwise, at step 4 the quality adaptation module 6140 directs the peer selection module 6110 to add a backup peer to the set of active peers, so that there is an updated number N of active suppliers. If at step 4 there are no backup peers available, then the quality adaptation module 6140 may adjust the FEC encoding overhead ratio α to adjust packet loss in the network. The quality adaptation module 6140 directs the stream management module 6120 (e.g., through a dynamic rate distribution module) to redistribute the streaming rate to the (N−K) good peers in the active set in order to meet the target streaming rate. The quality adaptation module 6140 also directs the peer selection module 6110 to select additional peers to add to the set of backup peers.

Referring again to FIG. 6, the content browsing and content recommendation module 6150 according to a specific embodiment is described. The content browsing and content recommendation module allows users to search for the content they are interested in. A user interface (UI) will allow the users to search content based on Electronic Program Guide (EPG) data such as:
a) title,
b) actor/actress,
c) director,
d) year,
e) country,
f) genre,
g) award,
h) category such as sports, TV serial, news, concert, and
i) any keyword in the story.

The query module 6160 facilitates obtaining information about peers as provided in the following details of operation. The query module 6160 sends probes to a remote peer to query for resource information of the STB such as CPU, memory, and upstream bandwidth. It can also query for status information, such as whether a peer is currently uploading, downloading, or in idle mode, and the reliability history of the peer. The query module 6160 can return the incentive history of a peer, which may be used to address fairness during peer selection by the peer selection module 6110.

For data management, a data management module stores the streamed data on a local storage device such as a hard drive. As the streaming is done over unreliable channel, using UDP for example, some packets might be lost during a session. The receiver might not have all of the packets due to use of the FF mechanism. Therefore, the data management module 6170 may contact the active suppliers after the streaming to download those missing segments so that the receiver has the complete file to be a supplier in future.

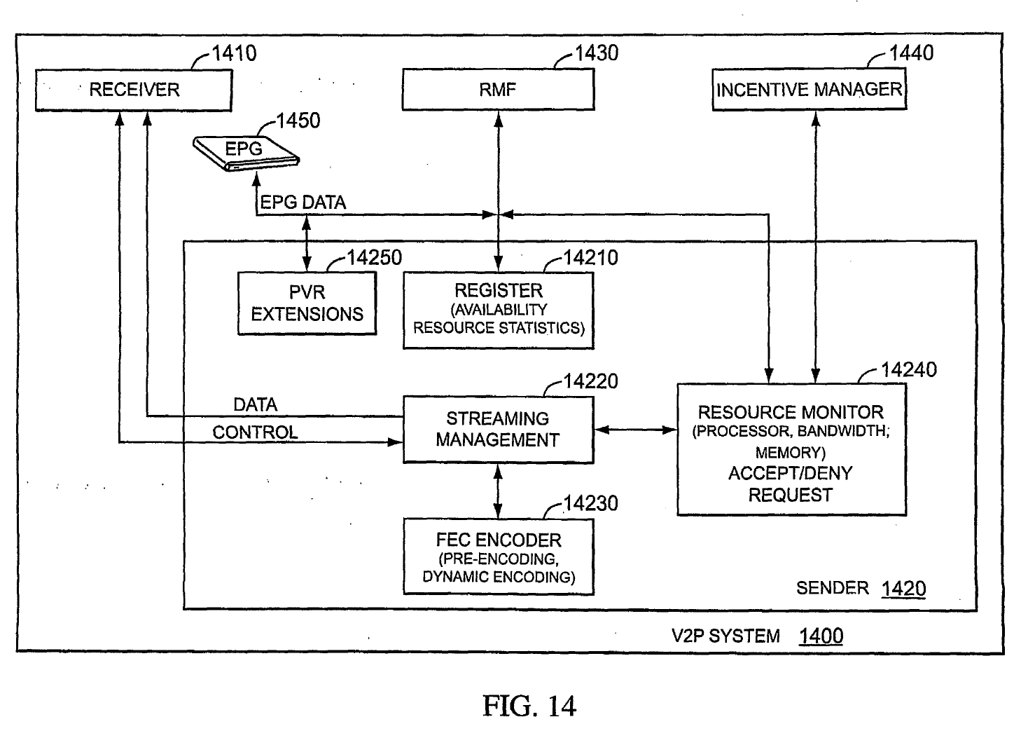

To understand how the suppliers operate, FIG. 14 presents a block diagram of a V2P system and further illustrates a sender (supplier) according to one embodiment of the present invention. According to FIG. 14, a V2P system 1400 comprises a receiver 1410, a sender 1420, a resource management framework (RMF) 1430, an incentive manager 1440, and an electronic program guide (EPG) 1450. Receiver 1410 interacts with sender 1420 to receive streaming data. Sender 1420 interacts with the RMF 1430 to register and announce content to the V2P system. Sender 1420 interacts with the incentive manager 1440 responsible for charging users and providing rewards to the appropriate entity. Sender 1420 interacts with the electronic program guide (EPG) 1450 to allow recording of content using personal video recorder (PVR) extensions.

According to FIG. 14, sender 1420 further comprises register module 14210, streaming management module 14220, FEC encoder module 14230, resource monitor module 14240, and PVR extensions module 14250, according to a specific embodiment. The register module 14210 registers an STB's resources and statistics as well as announces content to the p2p network. The streaming management module 14220 communicates with a receiver to provide data and to accept control signals. The FEC encoder module 14230 FEC encodes blocks in a media file corresponding to a content item. The resource monitor 14240 accepts or denies a new streaming request based on the STB's current status. It also reports to the incentive manager 1440 after contributing to a streaming session. The PVR extensions module 14250 interacts with an electronic program guide (EPG) 1450.

The register module 14210 registers its resources and statistics to the p2p network through RMF 630. It also registers, announces, or advertises new media content to the p2p network.

The streaming management module 14220 communicates with a receiver to provide data and to accept control signals. After a sender accepts a new streaming request, the streaming management module 14220 accepts a control connection from a receiver. According to the control connection, the streaming management module 14220 establishes a data connection to the receiver, reads data from the local storage device such as a hard disk, and sends data over the data connection. If the data is pre-encoded and an FEC encoding overhead ratio α of current encoded content matches with the requested a from the receiver, then the streaming management module 14220 only reads data and sends it to the receiver. If it is necessary to encode the data with a new α, the streaming management module 14220 communicates with the FEC encoder module 14230 to perform the FEC encoding.

The FEC encoder module 14230 encodes a block of a media file corresponding to a content item for streaming. According to specific embodiments, two exemplary FEC codes that V2P may use to encode media data with a specified FEC encoding overhead ratio α are the well-known Reed-Solomon and Raptor codes. Also, in other embodiments, a Reed-Solomon erasure code based on Cauchy matrices over finite fields and using XOR instead of arithmetic operations may be used to achieve faster encoding and decoding over a traditional Reed-Solomon code.

Table 2 presents exemplary encoding and decoding times using a modified Reed-Solomon erasure code, according to a specific embodiment. For example, a movie file may be divided into 1-second blocks or 0.5-second blocks at 1.1 Mbps and encoded to tolerate 20% packet loss. Encoding and decoding times are typical running the Reed-Solomon erasure code on a 2.4 GHz Linux machine with 2 GB memory.

As seen in Table 2, encoding requires more time than decoding. Moreover, encoding and decoding times are not linear with respect to the length of the block. If the block size is too long, the receiver has to wait a long time to receive all packets of the block before decoding the block. If the block size is too short, a bursty packet loss on one connection will drop a lot of packets and the rest of the packets from other connections will not have enough data to recover the block. For streaming at 1 Mbps, a 1-second block size may be typical. A STB with a processor running at 400 MHz or higher and having 128 MB or higher memory can support on demand encoding using a Reed-Solomon code to adjust to network fluctuations and device failures.

TABLE 2
Encoding and decoding times with for a Reed-Solomon erasure code.

| Block size | Encoding time (ms) | Decoding time (ms) |
|---|---|---|
| 1.0 | 67 | 30 |
| 0.5 | 18 | 7 |

Referring to FIG. 14, the resource monitor module 14240 monitors the local resources and status of a STB in order to decide whether to accept or deny a new streaming request. Also, the PVR extensions module 14250 interacts with an electronic program guide (EPG) 1450 to coordinate scheduling of recording events.

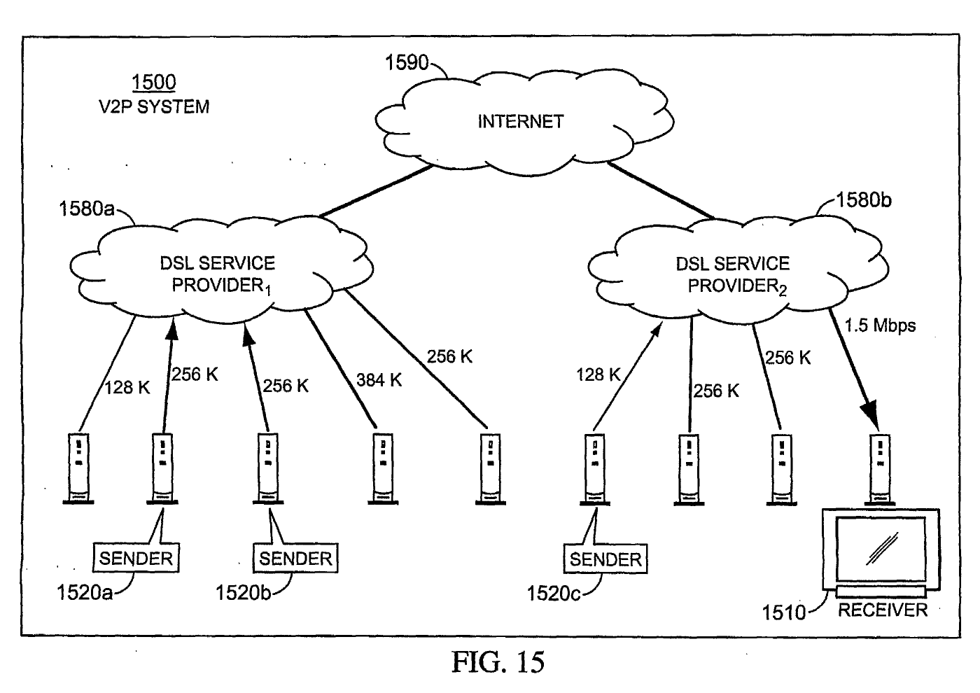

FIG. 15 shows an exemplary setup for evaluating the performance of a V2P system. According to FIG. 15, a V2P system 1500 comprises a receiver 1510, senders 1520, internet service providers (ISPs) 1580a and 1580b, hereinafter identified as ISPs 1580, and Internet 1590. Each of the receiver 1510 and senders 1520 may be configured with both a receiver module and a sender module, so that it may operate either as a sender or a receiver. Each of the receiver 1510 and senders 1520, shown here as personal computers, may be connected to the Internet 1590 via two different ISPs 1580. A set of senders may be chosen from both ISPs 1580, so that streaming data traverses through the Internet 1590 and the receiver 1510 experiences network fluctuations. During a streaming session, one or more of the senders 1520 may be powered off to simulate device failure.

According to a specific embodiment, a V2P system may be used in an asymmetric digital subscriber line (ADSL) access network deployment, where each sender has limited uplink capacity and a multi-sender solution is necessary to aggregate the whole streaming rate from a set of senders. V2P may also be implemented for use in higher bandwidth access networks, such as FTTx and xDSL networks with uplink bandwidths ranging from 20 Mbps-100 Mbps. In such environments, according to a specific embodiment, V2P does not need multiple senders to conduct a streaming of 1.5 Mbps (corresponding to MPEG-4 quality video streams) or even 3-5 Mbps (corresponding to MPEG-2 quality video streams). One sender can easily supply the entire streaming rate. Nevertheless, V2P may utilize backup peers for each streaming session in order to provide resilient streaming in the event of network fluctuations and peer failures, according to a specific embodiment. In this scenario, the V2P (N+M) streaming model becomes (1+M), where a streaming session uses one active supplier and M backup suppliers. Because each peer has high available uplink bandwidth, a streaming session does not require N active suppliers anymore. Nevertheless, M backups may be necessary to provide resilient streaming. Since each sender has sufficient capacity to serve multiple streaming sessions, backup suppliers assigned to one session can easily be active suppliers of another session.

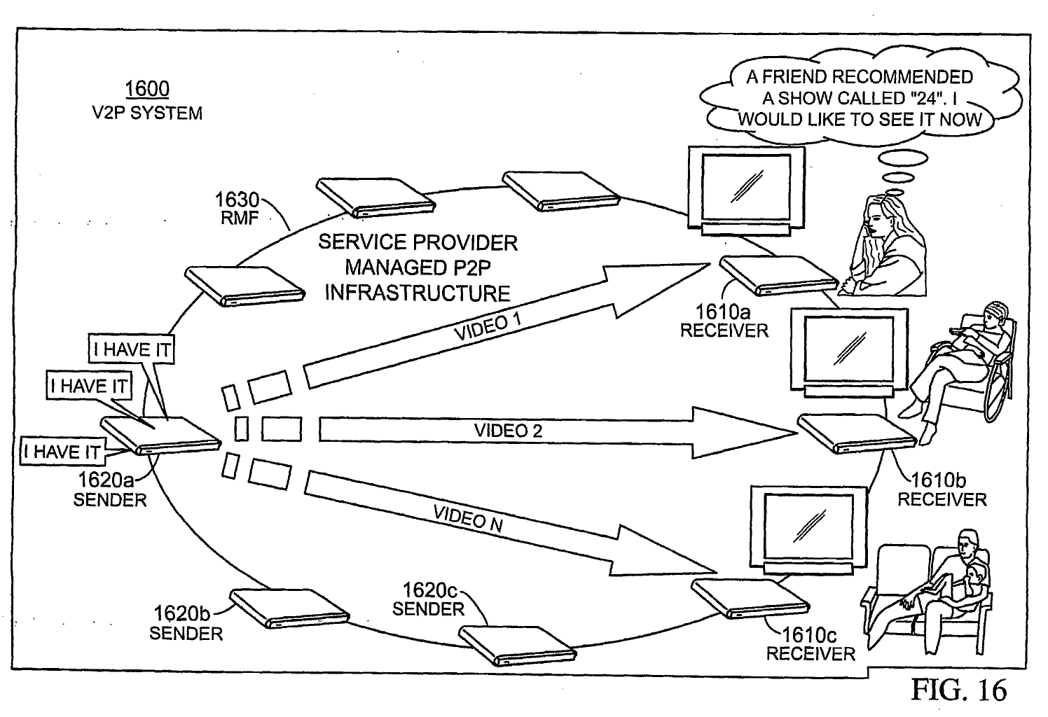

As the senders have enough uplink bandwidth to supply more than one stream concurrently, V2P is able to serve multiple video streams in parallel, according to a specific embodiment as shown in FIG. 16. One sender can supply multiple videos to multiple streaming sessions. A sender can even supply the same copy of a video to multiple streaming sessions, which is useful if a rare video is requested from many viewers. The number of concurrent video streams that can be supported by one supplier is not limited by V2P, but instead by the hardware I/O processing capabilities of the STB and the upstream bandwidth available. Implementing V2P in a high-bandwidth environment has some advantages, including:
a) only one active supplier plus two backups are necessary for a streaming session; and therefore, more streaming sessions can be supported;
b) the number of copies of a specific video available to the community is now multiplied by the number of concurrent streams that can be served from one supplier, which is especially useful for videos that were not recorded by many subscribers; and
c) the same resilience capabilities are ensured by V2P even when serving multiple video streams.
   Therefore, it has become clear that V2P has value in various homogenous networks and heterogeneous network deployments.

FIG. 16 illustrates a VoD-to-peer (V2P) system implemented in a high-bandwidth environment according to one embodiment of the present invention. According to FIG. 16, a V2P system 1600 comprises receivers 1610a, 1610b, and 1610n, hereinafter identified as receivers 1610, senders 1620a, 1620b, and 1620c, hereinafter identified as senders 1620, and a resource management framework (RMF) 1630. Receivers 1610, shown here as STBs, are receiving peers that receive streaming media from sender 1620a. Senders 1620, shown here as a STB, is a sending peer, or supplier of streaming media. It should be noted that any one of receivers 1610 may at other times act as sending peers. Similarly, any of one senders 1620 may at other times act as a receiving peer. Resource management framework (RMF) 1630 is a managed infrastructure, managed by a service provider, which manages the control and data connections among receivers 1610 and senders 1620 to perform on demand streaming of requested media. RMF 1630 also allows receivers 1610 to search V2P system 1600 for streamable content, such as media files, recorded from broadcast, recorded from senders, or downloaded and stored on senders 1620. RMF 1630 also allows receivers 1610 to receive content recommendations.

Even though one sender may be enough to provide the full streaming rate required by a streaming session in a high-bandwidth network environment, a streaming model based on (N+M) active supplier and backup suppliers may increase the overall system utilization versus (1+M) active suppliers and backup suppliers. Using the (N+M) streaming model, each supplier provides a fraction of the streaming rate even though it is capable of supplying whole. The following provides an estimate of the system utilization.

For example, assuming the following:
the community size (number of peers)=C,
multiplicative factor (Number of streams each peer can supply)=γ,
number of active senders for each streaming session=N,
number of backups for each streaming session=M,
streaming rate=R, and
each peer's uplink capacity=c,
   then the number of possible concurrent streaming sessions U, is given by the following relationship:

$$U = γ [ \frac{C}{N + M} ] = \frac{c}{R} [ \frac{C}{N + M} ] .$$

In the (1+M) model:
Suppose, C=1200, N=1, M=2, R=2 Mbps, γ=5, then
U=5(1200/(1+2))=2000.
   In the (N+M) model:
C=1200, N=4, M=2, R=2, γ=20 (as each peer supplies one fourth of the stream now γ=4*5=20), then
U=20 (1200/(4+2))=4000.

The analytical modeling illustrates that (N+M) has better resource utilization than (1+M) in a high-bandwidth environment. Instead of using a static solution such as (N+M) or (1+M), V2P may use an adaptive mechanism. For example, if the V2P system has enough copies of a particular resource (i.e., a particular video), it may be preferable use the (N+M) streaming model for better system utilization. If, on the other hand, the V2P system has only a few copies of a particular resource, it can provide streaming sessions using the (1+M) model.

It is possible to estimate the maximum utilization of the system as follows. Since the backups supply a fraction of data only during network fluctuation or during supplier migration during peer failure, each peer may utilize its capacity for active sessions instead of reserving it for backup sessions. Therefore, the maximum utilization U is represented by the following relationship:

$$U = \frac{c}{R} [ \frac{C}{N} ] .$$

For the above example, the maximum system utilization U=6000 for both (1+M) or (N+M) models.

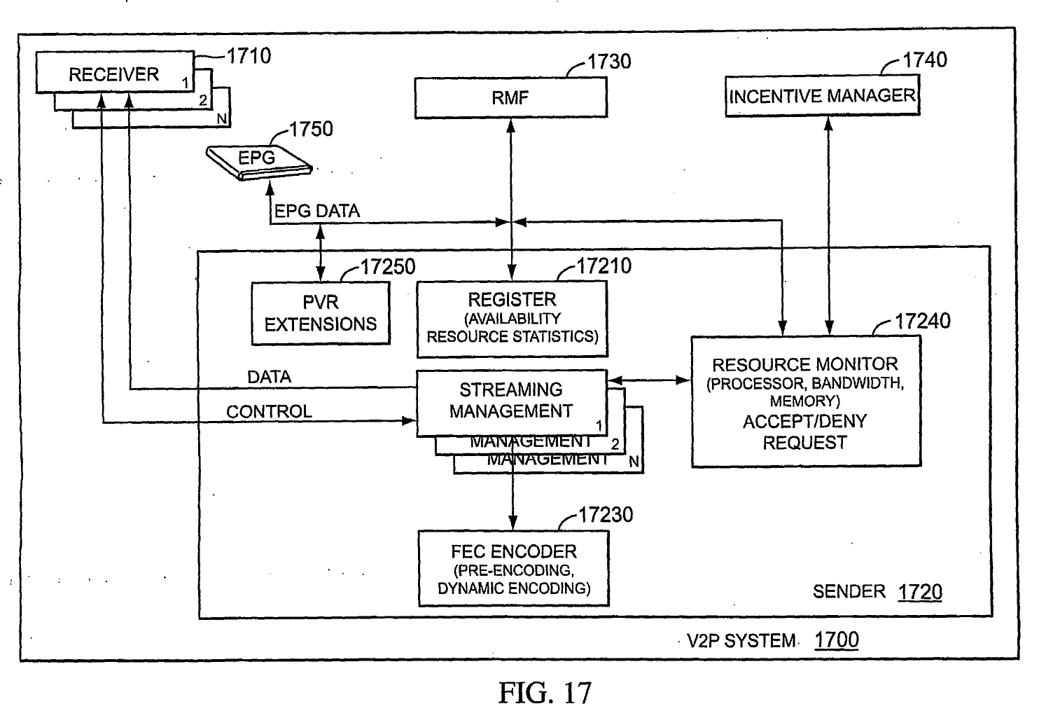

A V2P system may be implemented more generally in a heterogeneous community of both low and high bandwidth network environments. According to a specific embodiment, V2P can utilize a given sender more than once only if the sender has enough resources to contribute to multiple streaming sessions. Otherwise, each sender will be used in only one streaming session at any given time. FIG. 17 illustrates an extended sender architecture, where one sender may provide streams to multiple receivers, according to a specific embodiment. For each stream, the sender opens one stream management thread. Each instance of the stream management module is responsible for communicating with a receiver and taking action based on the control signals sent by the receiver. Each instance of the stream management module is also responsible for providing streaming video data to a receiver. Thus, V2P may support multiple server-like streaming sessions in a high-bandwidth environment. The generalized V2P inherits the advantages of both a p2p network environment using multiple sources and the advantages of a server-client environment by supplying multiple streaming sessions from one user.

In this generalized multi-source environment, a sender may contribute to as many streaming sessions as it can, based on its available resources. The number of concurrent streams V2P can support depends on various factors, such as:
a) the number of users who have a requested content item,
b) the uplink bandwidth of each user, and
c) the desired streaming quality.
   For example, a V2P system for a community of Cₗ low bandwidth peers and Cₕ high bandwidth peers can support up to γCₕ/(N+M)+Cₗ/(N+M) high quality streaming sessions where γ≧1 is a multiplicative factor that represents how many streams a supplier can contribute to. In a low bandwidth environment γ=1 m but in a high-bandwidth environment γ≈5 or more.

FIG. 17 is a block diagram of one embodiment of a V2P system, and further illustrates a sender according to one embodiment of the present invention. According to FIG. 17, a V2P system 1700 comprises receivers 1710, sender 1720, a resource management framework (RMF) 1730, an incentive manager 1740, and an electronic program guide (EPG) 1750. Receivers 1710 interact with sender 1720 to receive streaming data. Sender 1720 interacts with the RMF 1730 to register and announce content to the V2P system. Sender 1720 interacts with the incentive manager 1740 responsible for charging users and providing rewards to the appropriate entity. Sender 1720 interacts with the electronic program guide (EPG) 1750 to allow recording of content using personal video recorder (PVR) extensions.

According to FIG. 17, sender 1720 further comprises a register module 17210, streaming management modules 17220, FEC encoder module 17230, a resource monitor module 17240, and a PVR extensions module 17250. The register module 17210 registers a STB's resources and statistics as well as announces content to the p2p network. Each of the streaming management modules 17220 communicates with a receiver to provide data and to accept control signals. The FEC encoder module 17230 encodes blocks in a media file corresponding to a content item. The resource monitor 17240 accepts or denies a new streaming request based on the STB's current status. It also reports to the incentive manager 1740 after contributing to a streaming session. The PVR extensions module 17250 interacts with an electronic program guide (EPG) 1750 to coordinate scheduling of recording events.

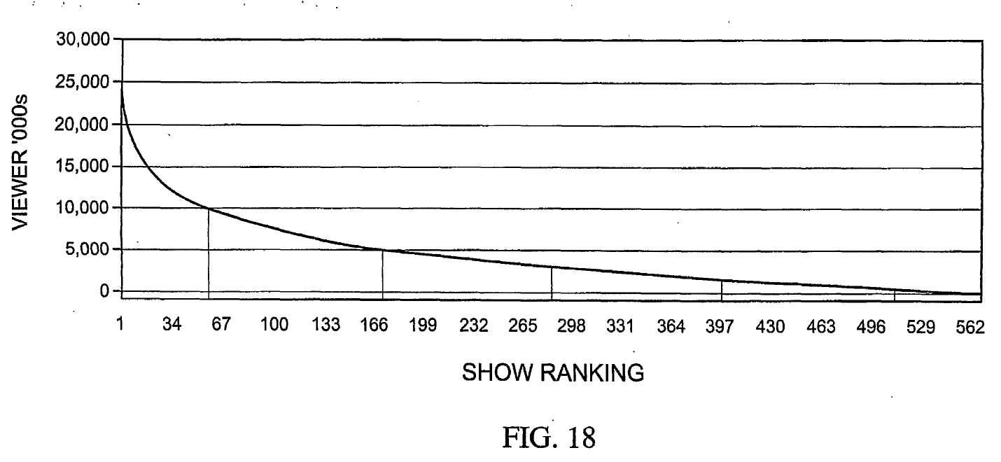

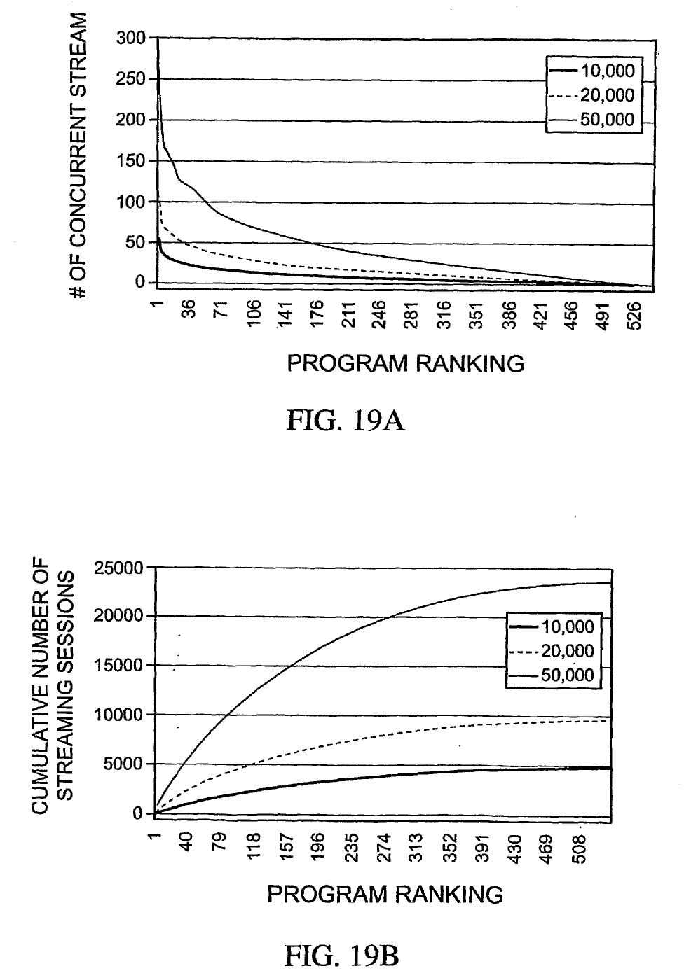

FIG. 18 presents a graph illustrating the long tail. Statistical sampling can be used to extrapolate wide viewing behavior. For example, FIG. 18 illustrates how the popularity of broadcast shows observes the long tail.

There are many variables to consider in order to model and understand the dimensions of a V2P deployment. For example, it may be necessary to estimate how many programs are recorded by a given community size in order to determine such dimensions as how many programs can be recorded, how many streams can be delivered by each sender, how many concurrent streams can be delivered, how many cumulative streams can be delivered in a network, how far back in time a V2P system can archive content, and how large a disk size each STB should have. For example, one estimate may be that subscribers record 25% of the broadcast content that they intend to watch. Other data, such as Nielsen ratings of TV shows, can be used to identify the percentage of the population of a given community size that watches a particular show. For example, a V2P system providing coverage for the top 500 TV shows may be modeled as follows:
let the size of the community=C (each user has a PVR);
the popularity of show i is pᵢ; and
the probability that a user who watches a show will record it=rᵢ;
Therefore, Probability that show i will be recorded in the community xᵢ=pᵢrᵢ and the
average number of recorded copies for show i in the community=Cpᵢrᵢ.

The following three scenarios are then considered:
1. Standard Definition (SD) quality streaming over DSL network (N=3, M=2)
2. Near DVD quality streaming over DSL network (N=5, M=2)
3. Near DVD or DVD quality streaming over fiber network (N=1, M=2).

For a DSL network deployment where the upstream bandwidth is limited and the quality of the video to be streamed to a single receiver is regular Standard Definition (SD) TV, the set of active senders requires a maximum of 3 and the set of backup senders requires a maximum of 2.

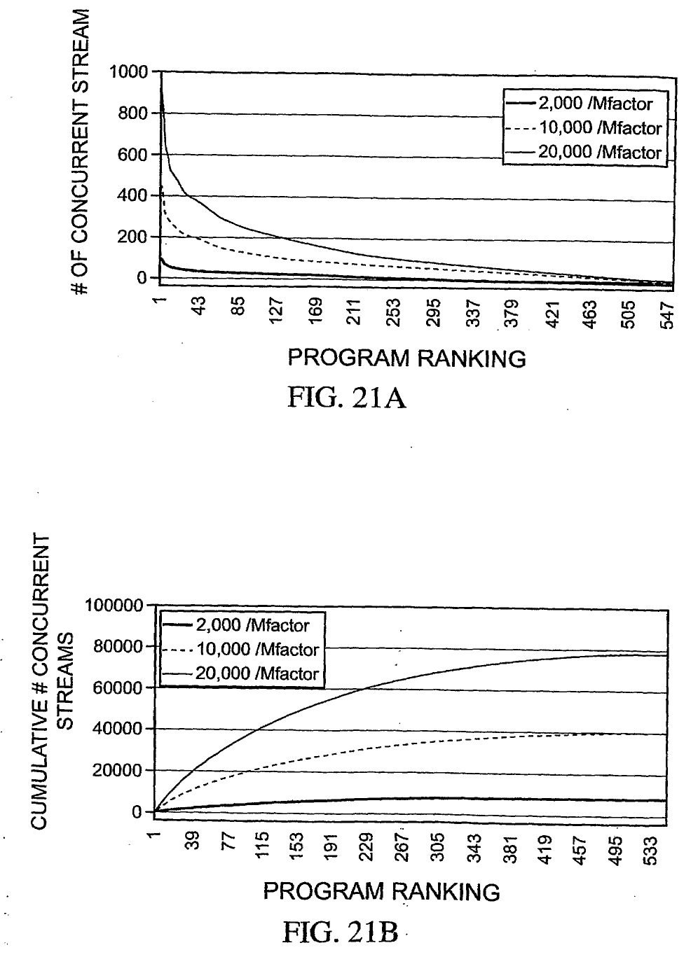

FIG. 21A presents a graph illustrating the number of concurrent streams that can be delivered for any given show for 3 different community sizes. For example, in a community of 50,000 households, V2P can support 375 concurrent streams of the top ranked show.

FIG. 21B presents a graph illustrating the maximum, or cumulative, number of streams that can be delivered by V2P for a given community size. For example, V2P is capable of delivering 24,000 parallel streams for a community size of 50,000.

For a DSL network deployment where the upstream bandwidth is limited and the quality of the video to be streamed to a single receiver is near DVD, the set of active senders requires a maximum of 5 and the set of backup senders requires a maximum of 2.

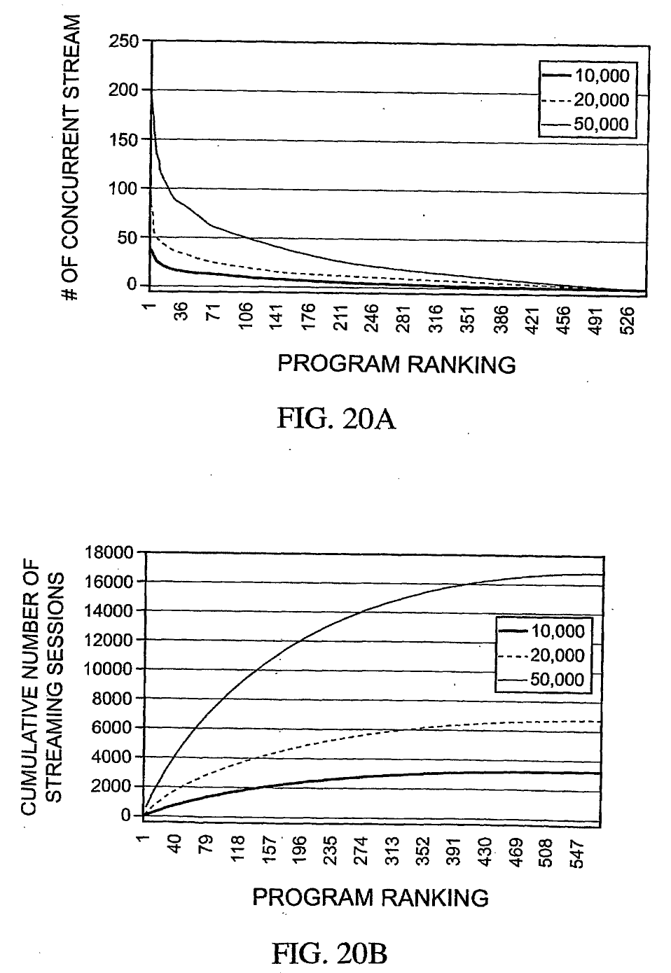

FIG. 20A presents a graph illustrating the number of concurrent streams that can be delivered for any given show for 3 different community sizes. For example, in a community of 50,000 households, V2P can support 200 concurrent streams of the top ranked show.

FIG. 20B presents a graph illustrating the maximum, or cumulative, number of streams that can be delivered by V2P for a given community size. For example, V2P is capable of delivering 17,000 parallel streams for a community size of 50,000.

For a fiber network deployment where the upstream bandwidth is 100 Mbps and the quality of the video to be streamed to 5 receivers is near DVD, the set of active senders requires a maximum of 1 and the set of backup senders requires a maximum of 2.

FIG. 21A presents a graph illustrating the number of concurrent streams that can be delivered for any given show for 3 different community sizes, according to a specific embodiment. For example, in a community of 20,000 households, V2P can support 925 concurrent streams of the top ranked show.

FIG. 21B presents a graph illustrating the maximum, or cumulative, number of streams that can be delivered by V2P for a given community size. For example, V2P is capable of delivering 80,000 parallel streams for a community size of 20,000.

As FIG. 21B shows, V2P is capable of delivering a total number of parallel streams that exceeds the size of the community, which allows supporting streaming to multiple TVs within a single household. Also, this allows support for a heterogeneous network. For example, a community could include STBs with or without PVR functions. STBs without PVR functions might only receive video streams but not supply video streams to the network. Also, a community could include STBs with either FFTX or DSL access.

Many parameters need to be factored into account to determine the scale of the archival capability offered by V2P, according to a specific embodiment. Some these parameters and basic assumptions for a specific embodiment are outlined below.

STB disk size:
1 Gb=˜1 hour of MPEG-2 SD video
½ Gb=˜1 hour of MPEG-4 near DVD video
⅓ Gb=˜1 hour of MPEG-4 SD video.

### Daily Usage:

Subscribers with PVRs watch ˜5 hours of TV per day, of which 25% are recorded (˜1.25 hours).
Therefore, the equation below helps approximate the STB disk size required for the archive period:
STB disk size=Months×30×1.25
STB disk size=Months×37.5.
   Hence for a 3 month archive the required disk size would be:
[symbol] STB disk size ˜120 Gb (MPEG-2 SD)
[symbol] STB disk size ˜60 Gb (MPEG-4 near DVD)
[symbol] STB disk size ˜40 Gb (MPEG-4 SD).

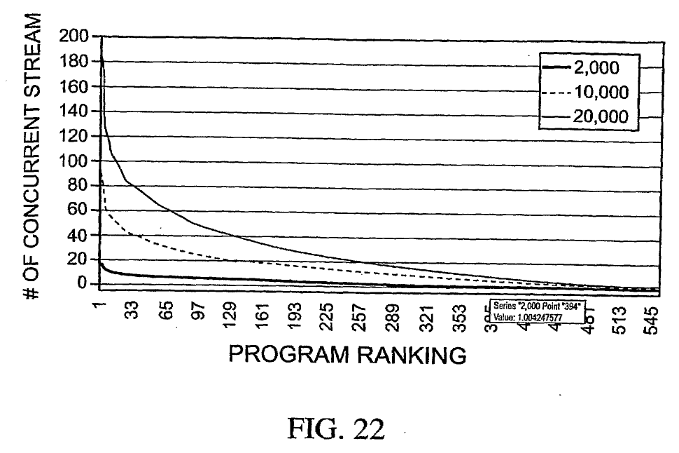

FIG. 22 is a graph illustrating the archival aspect of a V2P system, according to a specific embodiment. For example, according to FIG. 22, a V2P system may have complete coverage of the highest N rated shows (where N=394) for a community size M (where M=2000).

V2P utilizes a multiple-source video streaming technology. According to a specific embodiment, an essential pre-requisite is that the video file to be streamed by each of the sending sources is exactly the same in terms of encoded format, bit rate, and the start frame of the video.

One possible implementation of V2P is within a p2p network of STB/PVR devices. Owners of STB/PVR devices have several mechanisms for selecting the shows that they wish to record. For example, one mechanism is via an Electronic Program Guide (EPG).

A system clock of an STB may be periodically re-synchronized with a service provider's clock so that it remains within a predetermined tolerance, such as a few seconds. This synchronization ensures that an STB/PVR device may properly be scheduled to record broadcast programs. An obvious consequence of this clock difference is that various STB/PVR devices may not all begin recording a broadcast program at exactly the same time, and thus may not begin recording from the same start frame. Therefore, before V2P can stream a recorded program from multiple STB/PVR devices, a mechanism is required to identify a common start frame in the video file.

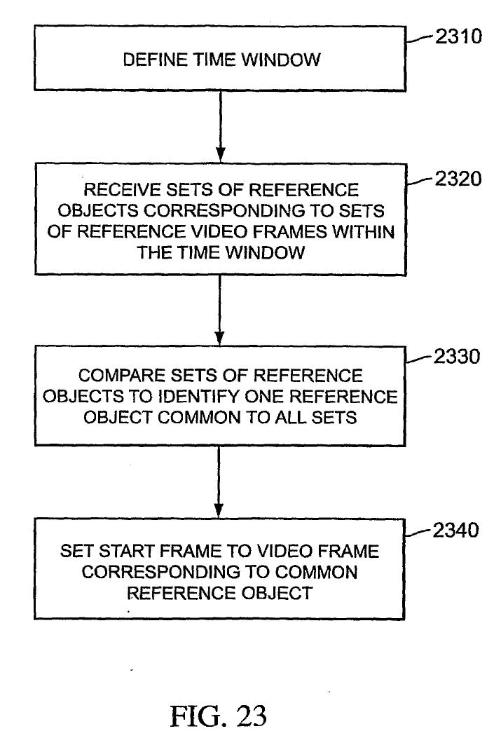

FIG. 23 is a flow diagram illustrating a method for identifying a common video frame according to one embodiment of the present invention. Prior to receiving streaming video data from a streaming session, a receiver may obtain a set of suppliers that will supply streaming video data. Each supplier supplies streaming video data from an individual copy of a video file corresponding to a particular content item, such as a broadcast program.

In this sequence, at step 2310, a receiver defines a time window, which may for example, be a time interval centered at the starting time of a broadcast program and extending forward and backward in time by a pre-determined synchronization tolerance. Clocks for client devices, such as STBs, connected to a service provider's network may be synchronized within a few seconds, so that a typical synchronization tolerance may be 3-5 seconds.

At step 2320, the receiver receives from each supplier a set of reference objects corresponding to a set of reference video frames occurring within the video file during the relevant defined time window. For example, in the context of MPEG-coded video files, each set of reference video frames may correspond to all I-frames occurring within each individual copy of a video file during the time window. Each reference object may represent all or part of the information contained in each video frame in the set of reference video frames. For example, each reference object may be a hash value computed using all or part of the information contained in each video frame in the set of reference video frames, using well-known hashing techniques. Hash values may be pre-computed by suppliers prior to a streaming session occurring.

At step 2330, the receiver compares the received sets of reference objects from all of the suppliers to identify a common reference object that is common to all of the received sets of reference objects. At step 2340, the receiver sets the start frame to the video frame corresponding to the common reference object identified at step 2340.

For example, a receiver defines a time_window, which is related to a synchronization tolerance of clocks among the STBs of a service provider. The clocks are typically synchronized with a few seconds tolerance, such as 3-5 seconds. With the help of the electronic program guide (EPG), the suppliers find the starting time of a show and then use the synchronization tolerance to determine how far back and how far forward to look inside a video file to find a common starting point. The time_window may be, for example, a time interval centered around the starting time of a broadcast and extending backward and forward in time by the synchronization tolerance. The suppliers generate reference objects corresponding to a set of reference video frames occurring within a video file during the time_window. For example in the context of MPEG-coded video streams (including MPEG-2 and MPEG-4), each Group of Picture (GOP) is independent of other GOPs. The suppliers may identify the beginning of each GOP, which is an I-frame. Then the I-frames occurring in each supplier's copy of a video file during the time_window need to be compared. If the senders send the I-frames to the receiver, it might not be technically feasible to send this amount of data in a short time. Each supplier may computes the hash value of the I-frames and send these hash values to the receiver. Instead of computing the hash of the whole I-frame, it is possible to continue this algorithm with partial data from each I-frame. Moreover, hash values can be computed offline so that they can be provided upon request from a receiver. When the receiver receives the sets of hashes, it can easily compare them and find a common I-frame that represents the starting position of the video files among this set of suppliers.

The method illustrated in FIG. 23 does not guarantee to select the exact start frame of a program. However, it will select a start frame that is close to the beginning of the program relative to the STBs synchronization tolerance. Advantages of this approach, according to a specific embodiment, are that it is a distributed solution and it also requires no video scene analysis to determine a start frame.

In this document, we have described the components of the proposed video streaming system V2P designed for a p2p network formed by STBs, according to various embodiments. According to specific embodiments, V2P is capable of overcoming uplink bandwidth constraint and achieving resiliency against network fluctuation and device failure using techniques such as intelligent peer selection, dynamic buffer management, tomography-based connection monitoring, and forward error correction code. V2P provides techniques to provide interactive feature such as pause, fast-forward, and fast-rewind in many-to-one video streaming, according to specific embodiments. V2P is extended to provide video streaming in fiber optic networks. A detailed analytical model for resource provisioning in both Fiber optic and DSL networks is also provided, according to a specific embodiment. An algorithm according to a specific embodiment also provides for synchronizing all video content recorded by different users so that V2P can stream using many-to-one streaming model.

In sum, the present invention according to various embodiments contemplates high quality and resilient video streaming using multiple sources, including active and backup suppliers, in a heterogeneous peer-to-peer network having an asymmetric bandwidth characteristic and possibly unreliable connections. According to various embodiments, the present invention contemplates achieving high quality and resilient streaming using a number of mechanisms including intelligent peer selection, network tomography-based connection monitoring, dynamic buffer management, dynamic rate distribution, and dynamic FEC encoding and decoding. The present invention also contemplates simulating interactive playback controls such as pause, fast-forward, and fast-rewind in an efficient manner.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed:

1. A system for providing on demand streaming data in a service provider's subscriber community peer-to-peer network, comprising:
a service provider operative to supply downloadable and recordable content that can be supplied as streaming data after it is downloaded or recorded;
a subscriber community peer-to-peer network of devices associated with the service provider and adapted to interface with a television set;
a receiver which is a node in the service provider's subscriber community peer-to-peer network; and
a set of suppliers, including active and backup suppliers, where each supplier is a node in the service provider's subscriber community peer-to-peer network and where each supplier is operative to supply on demand streaming data after downloading and/or recording content from either the service provider or from one or more of the other nodes;
wherein the receiver is operative to receive streaming data that is streamed on demand by the receiver from one or more suppliers in the set of suppliers.

2. The system of claim 1, wherein each of the devices is a set top box (STB) or a personal computer (PC).

3. The system of claim 1, wherein the streaming data is audio data, video data, or both.

4. The system of claim 1, further comprising a search engine of the subscriber community peer-to-peer network.

5. The system of claim 4, wherein the search engine further comprises a content browser, a content recommender, or both.

6. The system of claim 1, further comprising an incentive manager.

7. The system of claim 1, further comprising a digital rights manager.

8. A method for providing on demand streaming data in a service provider's subscriber community peer-to-peer network, comprising:
providing a subscriber community peer-to-peer network for subscribers of a service provider;
providing downloadable and recordable content that may be downloaded and/or recorded and subsequently supplied on demand as streaming data;
providing a search engine associated with the subscriber community peer-to-peer network; and
connecting the subscribers to the subscriber community peer-to-peer network, and enabling each subscriber to use the search engine, in order to search for content previously downloaded or recorded by other subscribers connected to the subscriber community peer-to-peer network, and to receive on demand such downloaded and/or recorded content as streaming data from one or more of the other subscribers.

9. The method of claim 8, wherein one or more than one of the subscribers is a set top box (STB) or a personal computer.

10. The method of claim 8, wherein the streaming data is audio data, video data, or both.

11. The method of claim 8, wherein the search engine comprises one or more of a content browser and a content recommender.

12. The method of claim 8, further comprising: providing an incentive manager.

13. The method of claim 8, further comprising: providing a digital rights manager.

14. A system for receiving on demand streaming data in a subscriber community peer-to-peer network, comprising:
a subscriber community peer-to-peer network;
a receiver of streaming data that is a node in the subscriber community peer-to-peer network; and
a set of suppliers of streaming data, including a set of active suppliers and a set of backup suppliers, where each supplier in the set of suppliers is a node in the subscriber community peer-to-peer network;
wherein the streaming data is comprised of multiple blocks and for each block of streaming data to be received on demand, the receiver is operative to:
utilize an FEC encoding overhead ratio;
signal each active supplier to send at an individually assigned data rate at least an individually assigned fraction of the block FEC-encoded using the FEC encoding overhead ratio;
receive segments of the FEC-encoded block wherein each segment represents at least a part of the individually assigned fractions;
decode the FEC-encoded block based on the aggregate of the segments and store the decoded block in a buffer;
monitor the performance of a network connection with each active supplier;
monitor the buffer to detect conditions that would result in overflow or underflow; and
based on the performance of the network connections and conditions of the buffer, perform quality adaptation to avoid reaching an underflow or overflow of the buffer.

15. A method for receiving on demand streaming data in a subscriber community peer-to-peer network, comprising:
selecting a set of suppliers from a set of candidate suppliers in a subscriber community peer-to-peer network to be a set of active suppliers and selecting another set of suppliers from the set of candidate suppliers to be a set of backup suppliers; and
for each block of streaming data to be received:
utilizing an FEC encoding overhead ratio;
signaling each active supplier to send at an individually assigned data rate at least an individually assigned fraction of the block FEC-encoded using the FEC encoding overhead ratio;
receiving segments of the FEC-encoded block wherein each segment represents at least a part of the individually assigned fractions;
decoding the FEC-encoded block based on the aggregate of the segments and storing the decoded block in a buffer;
monitoring the performance of a network connection with each active supplier;
monitoring the buffer to detect conditions that would result in overflow or underflow; and
based on the performance of the network connections and conditions of the buffer, performing quality adaptation to avoid reaching an underflow or overflow of the buffer.

16. The method of claim 15, wherein the streaming data is audio data, video data, or both.

17. The method of claim 15, wherein the subscriber community peer-to-peer network comprises any combination of set top boxes (STBs), personal computers (PCs), or mobile computing devices, each of which is operating as a supplier, receiver, or both.

18. The method of claim 15, wherein selecting a set of suppliers is based on any combination of one or more metrics including a supplier's supplying or receiving status, available uplink bandwidth, processing power, reliability history, path latency, packet loss, and fairness.

19. The method of claim 18, wherein reliability history is based on any combination of device failure rate, network connection time, and content availability of a supplier.

20. The method of claim 18, wherein fairness is based on any combination of load balancing and prior selection history of a supplier.

21. The method of claim 15, wherein monitoring the performance of the network connection with each active supplier is passive and is based on metrics of streaming data actually received from the supplier.

22. The method of claim 15, wherein monitoring the performance of the connection with each active supplier comprises detecting whether the active supplier has experienced a network fluctuation, failed, or deleted the content to be supplied as streaming data.

23. The method of claim 15, wherein monitoring the buffer comprises monitoring current buffer size, current playing rate, and current streaming rate.

24. The method of claim 15, wherein performing quality adaptation comprises one or more of the following:
rate distribution adjustment;
supplier set adjustment; and
FEC encoding parameter adjustment.

25. The method of claim 24, wherein the rate distribution adjustment comprises one or more of:
assigning a new assigned data rate for an active supplier; and
assigning a new assigned fraction for an active supplier.

26. The method of claim 24, wherein the supplier set adjustment comprises one or more of the following:
removing an active supplier from the set of active suppliers;
adding a backup supplier to the set of active suppliers; and
adding a candidate supplier to the set of backup suppliers.

27. The method of claim 24, wherein encoding parameter adjustment comprises one or more of the following:
utilizing a new FEC encoding overhead ratio; and
utilizing a new FEC encoding scheme.

28. The method of claim 15, further comprising obtaining a candidate set of suppliers from a search engine of the peer-to-peer network.

29. The method of claim 15, further comprising determining a common starting point within one or more copies of a media file to be used as a source of streaming data among the set of active suppliers of streaming data.

30. The method of claim 29, wherein determining a common starting point within a media file among the set of active suppliers includes:
defining a time interval;
receiving from each active supplier a set of reference objects, wherein each reference object corresponds to a reference frame occurring within a media file during the time interval;
comparing the received sets of reference objects identify a common reference object that is common to all sets of reference objects; and
setting the common starting point to be the reference frame corresponding to the common reference object.

31. The method of claim 30, wherein the media file is a video file, each reference frame is a video frame, and each reference object is a hash value.

32. The method of claim 30, wherein the time interval is related to a clock synchronization of devices connected to the subscriber community peer-to-peer network.

33. A system for supplying on demand streaming data in a subscriber community peer-to-peer network, comprising:
a receiver that is a node in a subscriber community peer-to-peer network; and
a set suppliers with streaming data, where each supplier in the set of suppliers is a node in the subscriber community peer-to-peer network;
wherein the streaming data is comprised of multiple blocks and for each block of streaming data to be supplied, each supplier is operative to:
receive a signal from the receiver indicating an FEC encoding overhead ratio to be utilized, an individually assigned data rate, and an individually assigned fraction of the FEC-encoded block resulting from an FEC encoding operation on the block utilizing the FEC encoding overhead ratio; and
send at least part of the assigned fraction of the FEC-encoded block at the individually assigned data rate.

34. A method for supplying on demand streaming data in a subscriber community peer-to-peer network, comprising:
for each block of streaming data to be received by a receiver in a subscriber community peer-to-peer network:
receiving a signal from the receiver indicating an FEC encoding overhead ratio to be utilized, an individually assigned data rate, and an individually assigned fraction of the FEC-encoded block resulting from an FEC encoding operation on the block utilizing the FEC encoding overhead ratio; and
sending to the receiver at least part of the assigned fraction of the FEC-encoded block at the individually assigned data rate.

35. The method of claim 34, wherein utilizing an FEC encoding overhead ratio includes setting the FEC encoding overhead ratio for subsequent FEC encoding of the block or using the FEC encoding overhead ratio to select a pre-encoded block.

36. A method for simulating fast-forward or fast-rewind playback of streaming video data, comprising:
receiving streaming video data at a streaming rate;
storing the received streaming video data in a buffer for subsequent playback at a playback rate corresponding to a normal speed;
playing the stored streaming video data from the buffer at a speed higher than the normal speed;
monitoring the buffer for an underflow condition where the streaming rate is less than the playback rate;
based on detecting an underflow condition, inserting a pre-determined video clip into the buffer between stored streaming video data.

37. A method for simulating fast-forward or fast-rewind playback of streaming video data, comprising:
receiving streaming video data from a video file at a streaming rate;
storing the received streaming video data in a buffer for subsequent playback at a normal playback rate corresponding to a normal viewing speed;
receiving a command for fast-forward playback at a speedup playback rate corresponding to a speedup viewing speed;
receiving streaming video data beginning from a jump point in the video file; and
playing the stored streaming video data from the buffer at playback rate higher than the normal playback speed to simulate playback at the speedup playback rate.

38. The method of claim 37, further comprising:
inserting a pre-determined video clip into the buffer between stored streaming video data.
